(19) United States
(12) Patent Application Publication
(10) Pub. No.: US 2016/0104180 A1
(43) Pub. Date: Apr. 14, 2016

(54) REAL-TIME PERFORMANCE MONITORING AND IMPROVEMENT TECHNOLOGY WITH TIERED ACCESS

(71) Applicant: Bernard Desautels, Montreal (CA)

(72) Inventor: Bernard Desautels, Montreal (CA)

(21) Appl. No.: 14/883,085

(22) Filed: Oct. 14, 2015

Related U.S. Application Data
(60) Provisional application No. 62/063,729, filed on Oct. 14, 2014.

(51) Int. Cl. G06Q 30/02; H04L 29/08; G06Q 10/06; H04L 29/06

(52) U.S. Cl. CPC G06Q 30/0203; H04L 67/42; H04L 67/306; G06Q 10/0639

(57) ABSTRACT

A centralized real-time performance monitoring and improvement technology, including methods and system which permit multiple tiers of users, including a manager tier, an interviewer tier and a representative tier to collaborate using a same database to select, under directions from a manager, clients to undergo telephone interviews, by an interviewer perform the telephone interview and provide the results, and a representative review the results of interviews. Personalized results based on tier and client associations are available to representatives in real time to track performance with respect to individual clients and over time. A server acts as a gateway providing differentiated access to functionality and to data to the different tiers and can perform a simultaneously login-based, a tier-based, and a permissions-based access control. Abstract not to be considered limiting.

### TECHNICAL FIELD

The subject matter disclosed relates generally to the field of performance tracking and performance improvement in a business to business setting. The subject matter disclosed also relates generally to the field of interview-based performance tracking and more particularly telephone interview based performance tracking.

### BACKGROUND

To improve offering to clients (products and services), as well as to improve customer satisfaction, experience and loyalty in a business to business context, managers in supplier companies generally need to access client sentiment and insight, more specifically, information pertaining to which degree clients appreciate or do not appreciate various aspects of the supplier company and why.

This type of information can generally be accessed via three sources:
Supplier sales reps, which can relay some client sentiment to management
Formal customer complaint systems, which tend to channel the complaints of the most irritated customers, and
Periodic customer satisfaction surveys (for example, every one or two years)

These sources have advantages and limitations. One major limitation is the absence of independently acquired, client-by-client recurrent feedback, in a B2B context where each client is worth a lot and therefore where managerial agility and continuous improvement are highly desirable.

More specifically, customer sentiment acquired via the first source (supplier sales reps) can be filtered to various degrees by the sales reps and is often provided in the form of anecdotal information; customer sentiment acquired via complaint systems exclusively pertains to cases of quite unsatisfied clients, and does not cover all dissatisfied customers because many may simply not complain and change suppliers over time; the third source, customer satisfaction surveys, are done periodically and offer a “snap shot” of B2B customer sentiment, more often than not a long time (weeks, months or years) after specific incidents that may have generated the evaluated customer sentiment.

None of the above is a structurally continuous process and therefore all of the above sources and systems limit management's ability to act daily to improve client-by-client satisfaction, experience and loyalty on a sustained or continuous basis.

More specifically, any B2B survey of clients need to be administered via regular phone interviews because web surveys yield very low response rates (from 5% to 12%); in a B2B context, where client lists may be as limited as 200 or 100 contacts, such limited web-survey response rates would yield a very limited number of completed interviews and consequently very little information for management to base customer improvements on.

### SUMMARY

In accordance with a broad embodiment, there is provided a centralized real-time performance monitoring system comprising a server architecture accessible for communication over a data network. The server architecture comprises a computer-readable memory which comprises at least one client data set comprising a plurality of client profiles and comprising for each of the plurality of client profiles client profile data, and a user data set comprising tiered user profiles each of which belonging to at least one tier from amongst a set of tiers comprising at least an interviewer tier, and a representative tier, wherein each tier is associated with a different level of access to data in the computer-readable memory. The server architecture further comprises a network interface configured to receive requests from remote devices, the request being associated with a user profile and to transmit responses to requests to the remote device from which the corresponding request originated. The server architecture further comprises the operational logic in operative communication with the network interface comprising computer-readable instructions instructing a processing entity to generate and transmit to an interviewer remote device associated with an interviewer user profile of the interviewer tier a directive indicative that an interview is to be performed on a particular client. The server architecture further comprises the operational logic in operative communication with the network interface comprising computer-readable instructions instructing the processing entity to accept a result-providing transmission associated with the interviewer user profile from the interviewer remote device comprising result data indicative of interview response from the particular client, and in response to the results-providing transmission, access the computer-readable memory to store the result data in association with the particular client profile. The server architecture further comprises the operational logic in operative communication with the network interface comprising computer-readable instructions instructing the processing entity to determine an association between the particular client and a representative user profile associated with the representative tier. The server architecture further comprises the operational logic in operative communication with the network interface comprising computer-readable instructions instructing the processing entity to at least partially on the basis of the presence of the result data and of the association between the representative user profile and the particular client, generate a report transmission comprising at least a portion of the result data, and cause the transmission of the report transmission to a representative remote device associated with the representative user profile.

In accordance with another broad embodiment, there is provided a method for providing differentiated real-time access to an operational data set stored in a computer-readable memory having comprising at least one client data set comprising a plurality of client profiles and comprising for each of the plurality of client profiles client profile data, the real-time differentiated access being provided to different user profiles belonging to at least one tier from amongst a set of tiers comprising at least an interviewer tier and a representative tier, wherein each tier is associated with a different level of access to the operational data in the computer-readable memory, the method providing different level of access to the operational functions and data. The method comprises generating a directive indicative that an interview is to be performed on a particular client. The method further comprises transmitting the directive to an interviewer remote device associated with an interviewer user profile of the interviewer tier. The method further comprises receiving a result-providing transmission associated with the interviewer user profile from the interviewer remote device comprising result data indicative of interview response from the particular client, and in response to the results-providing transmission, accessing the computer-readable memory and storing the result data in association with the particular client profile. The method further comprises determining an association between the particular client and a representative user profile associated with the representative tier. The method further comprises at least partially on the basis of the presence of the result data and of the association between the representative user profile and the particular client, generating a report transmission comprising at least a portion of the result data and transmitting the report transmission to a representative remote device associated with the representative user profile.

In accordance with another broad embodiment, there is provided a centralized real-time performance monitoring system comprising a server architecture accessible for communication over a data network. The server architecture comprises a computer-readable memory comprising an operational data set comprising and a user data set comprising tiered user profiles each of which being of at least one tier from amongst at least a management tier, an interviewer tier, and a representative tier, wherein each tier is associated with a different level of access to the operational functions and data. The operational data set comprises at least one feedback campaign data set comprising question data, the question data including at least one interview question to be asked orally to a client over the phone, and at least one client data set comprising a plurality of client profiles and comprising for each of the plurality of client profiles client profile data. The server architecture further comprises a network interface configured to receive requests from remote devices, the request being associated with a user profile and to transmit responses to requests to the remote device from which the corresponding request originated. The server architecture further comprises operational logic comprising computer-readable instructions for causing a processing entity to receive the access requests from the network interface, to implement an access gateway providing tiered access to the operational data and to operational logic functions, and to generate the responses to the access requests. The access gateway provides a manager tier access for requests associated with a manager tier user profile, the first tier access comprising access to functions to modify the campaign data from a particular feedback campaign profile in the operational data set. The access gateway further provides an interviewer tier access for requests associated with a interviewer tier user profile, the interviewer tier access comprising access to receive from the operational data set the client profile data from a particular client profile, receive from the operational data said the feedback campaign profile data from a particular feedback campaign profile associated with the particular client profiles, and provide to the operational data set response data associated with the particular client profile, the response data comprising answers to client question provided orally over the phone. The access gateway further provides a representative tier access for requests associated with a representative tier user profile, the representative tier access comprising access to receive from the operational data set the response data associated with the particular client profile.

### BRIEF DESCRIPTION OF THE DRAWINGS

The invention will be better understood by way of the following detailed description of embodiments of the invention with reference to the appended drawings, in which:

FIG. 1 shows a conceptual perspective view of a real-time performance monitoring system in accordance with an exemplary embodiment;

FIG. 2 is a block diagram illustrating a server, database and remote device of the real-time performance monitoring system of FIG. 1;

FIG. 3 is a block diagram illustrating a non-limiting example of data organization within the database of FIG. 2;

FIG. 4a is a block diagram illustrating in more details a user category portion of the data organization of FIG. 3;

FIG. 4b is a block diagram illustrating in more details a core category portion of the data organization of FIG. 3;

FIG. 4c is a block diagram illustrating in more details a campaign category portion of the data organization of FIG. 3;

FIG. 4d is a block diagram illustrating in more details an interview category portion of the data organization of FIG. 3;

FIG. 5 is an event flow diagram showing exemplary interactions between the remote device an server of FIG. 2;

FIG. 6 is representation of a screen capture of a login screen presented on the remote device of FIG. 2;

FIG. 7a is a representation of a screen capture of a graphical user interface in accordance with an exemplary embodiment showing a campaigns pane implemented on a manager computer;

FIG. 7b is a representation of a screen capture of the graphical user interface of FIG. 7a showing a results pane;

FIG. 7c is a representation of a screen capture of the graphical user interface of FIG. 7a showing a clients pane;

FIG. 8a is a representation of a mobile device showing a graphical user interface in accordance with an exemplary embodiment presenting a welcome pane;

FIG. 8b is a representation of a mobile device showing the graphical user interface of FIG. 8a presenting a results pane;

FIG. 9a is a representation of a screen capture of a graphical user interface in accordance with an exemplary embodiment showing a welcome screen implemented on in interviewer system;

FIG. 9b is a representation of a screen capture of the graphical user interface of FIG. 9a showing a job pane;

FIG. 9c is a representation of a screen capture of the graphical user interface of FIG. 9a showing an interview window;

FIG. 10a is a representation of a screen capture of a mobile device graphical user interface in accordance with an exemplary embodiment showing a welcome pane on a vp mobile device;

FIG. 10b is a representation of a screen capture of the mobile graphical user interface of FIG. 10a showing a statistics pane;

FIG. 10c is a representation of a screen capture of the mobile graphical user interface of FIG. 10a showing performance progress over time;

FIG. 11a is a representation of a screen capture of a graphical user interface in accordance with an exemplary embodiment showing an interviewer pane implemented on an administration station; and

FIG. 11b is a representation of a screen capture of the graphical user interface of FIG. 11a showing a business unit pane.

### DETAILED DESCRIPTION

In a continuous improvement accelerator system phone interviews are generated that are typically short (two questions, less than one minute) with important B2B partners, (e.g. customers of a supplier). These interviews may be done for all such partners (not just a sample), on a regular basis, and yields benefits such as: high response rate (around 75-85%), client by client feedback results which are highly actionable because they pertain to each specific client and are published in managers or representatives or VPs mobile devices, instantly after the interview's end. The system also provides automated follow-up interviews (after managerial improvements to customers have been made) and provides aggregated results to the users for more strategic analysis and decision making. The system is a radical improvement over the three sources of customer sentiment described above since it covers the three angles (the anecdotal information of the sales reps, the complaints of the complaint system, and the statistical value of a formal survey) in a process that delivers instant feedback results in user mobile devices. Moreover, the system may provide additional rich information not provided in the three above-mentioned sources, because it may be made systematic (contacts all clients), recurrent (each client can be called 2 or 3 times per year), and obtaining the sentiment and suggestions from all customers, including satisfied customers, those who do appreciate the supplier and wish for it to improve even more.

A novel technology is provided to allow unprecedented performance tracking and continuous improvement. Unlike prior systems that were neither continuous, real-time nor centralized, herein is provided a system which allows continuous performance tracking and improvements that is deployed as a centralized service that is real-time accessible to multiple users and tiers of users.

The system may uniquely provide telephone interview data in a purely web-to-web architecture, thus integrating the reliability of phone-based feedback generation, in terms of responsiveness and quality of feedback, with the convenience and accessibility of web access. With this system response rates of 85%, exceeding even phone polling services (which may be around 65%) have been achieved, providing far more complete and comprehensive tracking data.

Prior art surveys that are performed as part of a survey campaign resulted in a single report indicative of the survey results. The report generally comprised an aggregation of data collected in the survey, which may include averaged values and other processed data. Occasionally, raw data from one particular respondent may have been included, for example as a quote to provide color to a particular statistic generated in the survey. Unlike the prior art, the technology disclosed allows the distribution, including the publication to mobile, of individual interview results to particular users that are concerned by the results. For example, the system provides access to representatives that are associated with certain clients with access to the results from interviews with those clients. These results may be accessible in real-time. Thus the system can provide individualized reports that are tailored to specific users in accordance with their particular position and/or to their particular associations or permissions.

The novel solution also allows unprecedented organization of data and provides a tool that allows streamlining of performance tracking tasks to such an extent that the tool may be used to generate continuous and real-time metrics to inform a continuous improvement process. The technology provided herein may be used as an improvement accelerator, providing key information required for improvement to key personnel at key times. As an improvement accelerator, the tools provided also allow managerial oversight, not just of performance but also of improvement efforts, including utilization of the improvement accelerator itself.

This technology is uniquely well suited for company-level improvements as it provides a uniquely “B2B” (business-to-business) solution. Unlike phone-polling services where a same individual is generally never reached twice, the present system provides a platform for follow-up data generation chronological tracking of client satisfaction through time.

Moreover the present technology provides a portable solution that can be provided as a platform, as a service, or even as a complete key-in-hand solution for service providers, as described in more details herein.

Herein is described, inter alia, a method and system for measuring client satisfaction in B2B enterprises and distributing results instantaneously to end-users (e.g. the providers' managers or representatives). The method involves a hybrid approach which combines old and new methods in a novel manner that exhibits a high participation rate among B2B customers (due in part to the use of telephone interviews) as well as innovative client-by-client results distribution using, for example, publication to mobile devices. In one example, very short customer interviews are initiated following an event, e.g. immediately after the event. Customer interviews may be done by telephone and the results are provided as the interview is being conducted and may be uploaded/sent using a web service to grant immediate access to the data, thus allowing the enterprise to take immediate actions when notified that a client is unsatisfied or otherwise react to client feedback. This technology provides a business a rapid reaction capability to improve performance and increase client satisfaction and loyalty.

Client experiences that are below and above average are often those that matter the most in client interviews. This type of information allows the business (using the technology described herein) to identify aspects of their (e.g. service) offering that were well received by their clients and to identify aspects that were not well received by the user. This in turns allows the business to fine tune its practice to improve reception of its offering, e.g. by promoting, pushing or merely preserving aspects that are well received and improving, abolishing or modifying aspects that were not well received. Ideally, in order for the interview to be effective and reflective of the facts, it is useful to capture the client's experience before it fades away. Accordingly, the present technology permit a trigger to interview a client immediately after a business event to monitor (e.g. an interaction with a representative, a product delivery, an installation, a purchase, a service renewal, an acquisition, a sale, a sales pitch, a site visit or consultation, etc. . . . ) and, e.g., only after the business event.

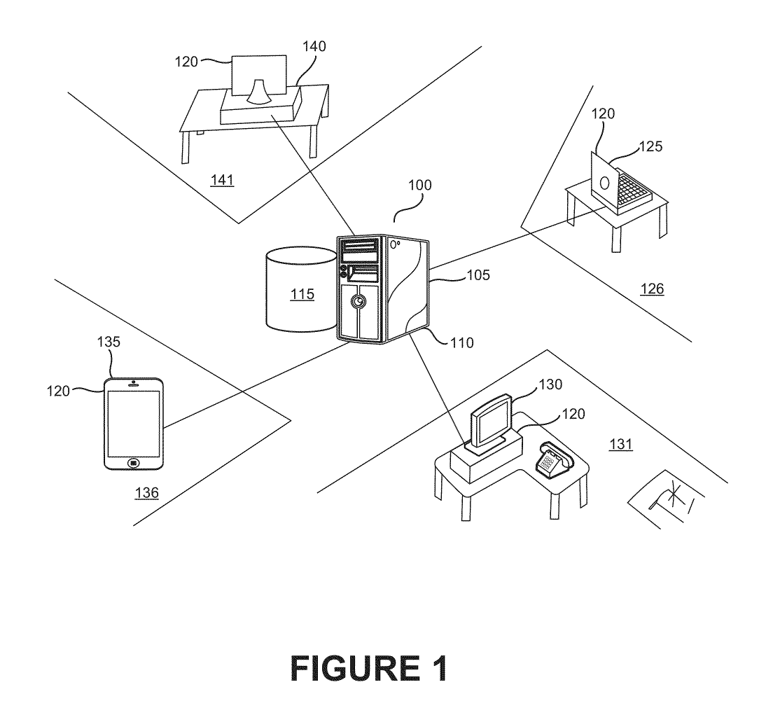

FIG. 1 illustrates a real-time performance monitoring system 100, in accordance with an exemplary embodiment. The real-time performance monitoring system 100 comprises a server architecture 105. The server architecture 105 of this example, comprises a single server 110 linked to a data repository 115 which comprises computer-readable memory where operational data is stored. The server architecture 105 is in communication with remote devices 120 are various locations, including an manager computer 125 at a manager premise 126, an interviewer system 130 at an interviewer premise 131, a representative mobile device 135 at a representative's location 136, and an administrator station 140 at an administrator premise 141. The various locations are not necessarily in the same place and indeed can be considerable distances apart.

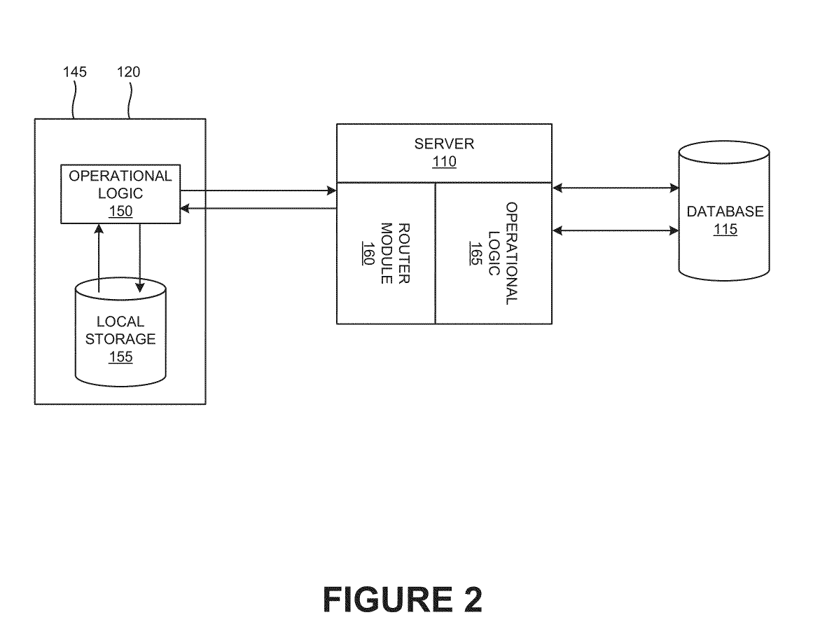

FIG. 2 illustrates the server architecture in the context of a relationship with a particular remote device 145. In this particular example, the server 110 comprises two modules, a router module 160 and server operation logic 165. The server 110 is in communication with and can perform multiple exchanges with the database 115. The server 110 is also in communication with the particular remote device 145. The particular remote device 145 is a remote device 120, and has local storage 155, represented here as a single storage receptacle, but the variety of alternative forms will be appreciated. The particular remote device 145 is also provided with device operational logic 150, which is logic used in exchanges with the server 110 and in treatment of data from or for the server 110.

In the particular example provided here, the server architecture 105 is implemented using a server-side web application using a Node.js runtime environment. That being said, the present technology is not limited to any particular runtime environment. In this particular example, Node.js is used, which provides an event-driven scalable architecture that permits real-time web publishing. The server 110 of this example is implemented using a server-as-a-service provider, whereby the server architecture is uploaded to a cloud and physically implemented by running the interpretive programming of the server 110 on one or more remote devices in the cloud. This is again, merely one possible implementation of the server architecture 105. In an alternative embodiment, the server 110 may be located at a local facility and implemented on a single machine, using the same interpretive programming or using compiled program instructions.

The database 115 is provided on a computer-readable memory which may be collocated with the server 110 but in this example, the database is provided by a cloud-based service that is accessible by the server 100 through a suitable interface via, e.g., the internet. The database 115 is shown here as unitary, but distributed storage schemes and/or back-up redundancies may be used as well.

In this particular example where the server 110 is implemented using Node.js, the router module 160 is implemented using an Express.js framework which provides efficient routing of requests which are received according to the REST API towards application modules which treat these requests. The server 110 has a network interface over which it communicates with remote devices 120. The network interface controls communications over the network, in this example the internet, and is configured to receive and transmit communications to and from remote devices 120, including to receive requests from the remote devices 120 and to transmit responses to these requests back to the remote devices 120. The router module 160 receives incoming communications and routs them to the appropriate function in the operational logic 165 or services them directly if they do not require intervention by operational logic 165. The router module 160 also receives information to communicate to remote devices 120 from the operational logic 165 and causes them to be transmitted to the intended recipient. Thus as more fully described herein, the router module 160 is implemented as computer-readable instructions instructing a processing entity, in this case a cloud-based server, to perform routing of communications to and from the operational logic 165 and also to service certain communications directly.

The operational logic 165 is programming logic provided in the server 110 to treat communications. In particular, the operational logic 165 implements a tiered-access gateway to the database 115 and services requests requiring access to the database 115 and provides responses to the requests, e.g. comprising data accessed from the database 115. In this particular example, the operational logic is provided in the form of JavaScript interpretive language instructions, however it is to be understood that the programming may be implemented using other languages including compiled languages, e.g. for a local physical server.

The database 115 comprises data used by the server 110. In this particular example, the database 115 is implemented using MySQL and is running on a cloud-based database service. Consequently, communication between the server 110 and the database 115 comprises network communication, however in alternate embodiments the database may be local to the server. This is, however, merely an exemplary embodiment. In an alternative embodiment, the database 115 may be implemented in storage media that is local to the server 110 using MySQL or another database management system.

In this exemplary embodiment, the particular remote device 145 does not have an installed program to communicate with the server 110. Rather, the particular remote device 145 has an internet connection and a browser which is used to connect to the server 110 which transmits to the particular remote device 145 the device operational logic 150 describing that particular remote device 145's role in the real-time performance monitoring system 100. More particularly, the device operational logic 150 comprises JavaScript in an AngularJS framework.

In this particular non-limiting implementation, the device operational logic 150 communicates with the server architecture 105 and more particularly with the server 110 using a REST API interface.

The server architecture 105 serves as a centralized system with which various actors can collaborate to monitor performance and to inform and track improvement. The system 100 provides a tool to allow real-time feedback generation through telephone interview in an environment that is nonetheless web-to-web. To this end, every user of the system, whether at the manager computer 125, the interviewer system 130, the representative mobile device 135 or the administrator station 140 accesses a same set of data via the server architecture 105 which provides a gateway to the data set. The server 110 acting as a gateway provides tiered access to the data such that each tier of user is provided respective access to respective portions of the data, as an additional layer to user permissions. The unique data organization, described in more details herein, and the unique server operational logic serve to provide the server architecture with new functionality of the novel real-time performance monitoring system 100. Moreover, in this particular example, the server architecture 105, and more particularly here the server 110, also comprises device operational logic in the form of JavaScript code which it provides to the remote devices 120 thereby providing them with the functionality to work in the real-time performance monitoring system 100.

When a remote device 120 access the server 110, e.g. using a browser and querying a URL linked to the server 110, the server 110 provides the remote device with web content such as html files, but also the logic (in this example JavaScript) used for the system. The device operational logic 150, so obtained by the server 110, may comprise logic for communicating with the server 110, for accessing the database 115 (in this example through the server 110), for presenting operational data to a user of the remote device 120, for accepting input from the user of the remote device 120, for manipulating and/or modifying operational data, and/or for receiving new data to provide to the database 115 as new operational data. The device operational logic may be stored in local storage, such as local storage 155 at the remote device 120 and may comprise computer-readable instructions for instructing a processing entity to perform functions described and provided herein.

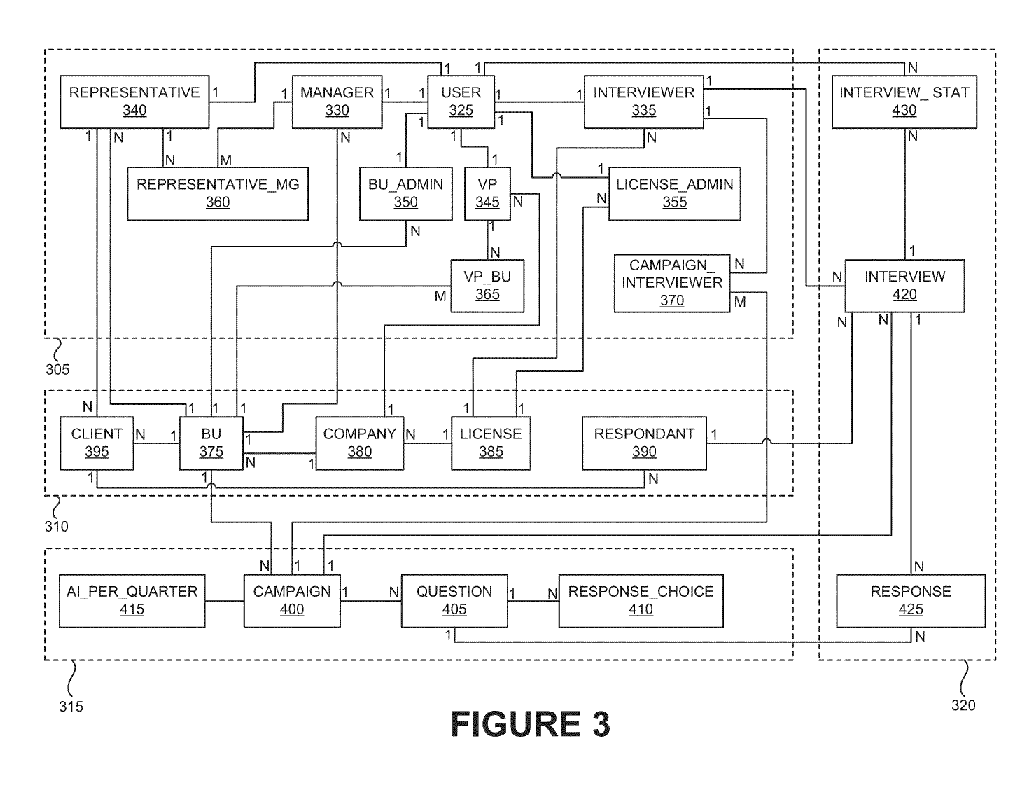

FIG. 3 illustrates the logical organization of data in the database 115 according to one example of implementation. The present example is provided in order to illustrate one possible arrangement of data which has been found to be useful, however it is not meant to preclude data structures, simplifications, additional features, and more generally variants on the design that a skilled person may consider.

The data shown here is generally classed into four categories. A user category 305 regroups a set of tables that generally comprise data on users. A campaign category 315 comprises data pertaining to one or more interview campaigns. An interview category 320 comprises data related to individual interviews. A core category 310 comprises the remainder of the data, which includes data related to customers of the real-time performance monitoring system 100, customer licenses, clients to monitor/interview, etc. . . . In this particular example, user data is generally contained in the user category 305 and operational data is generally contained in the core category 310, campaign category 315 and interview category 320.

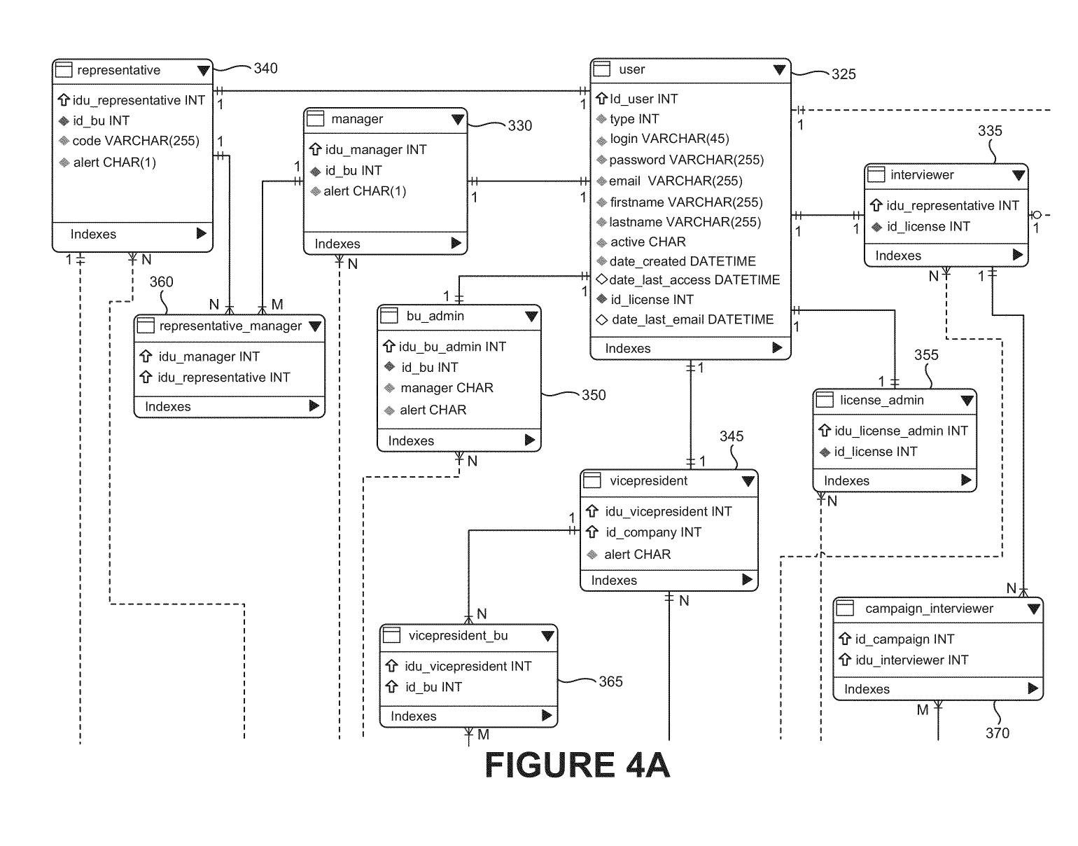

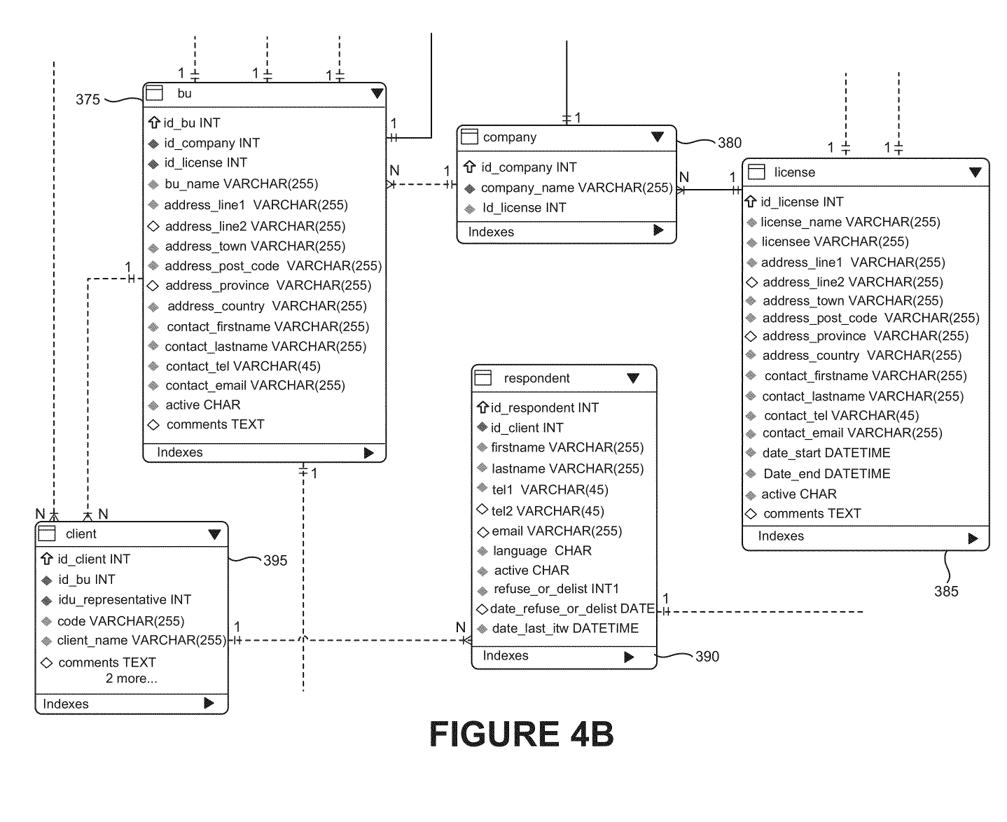

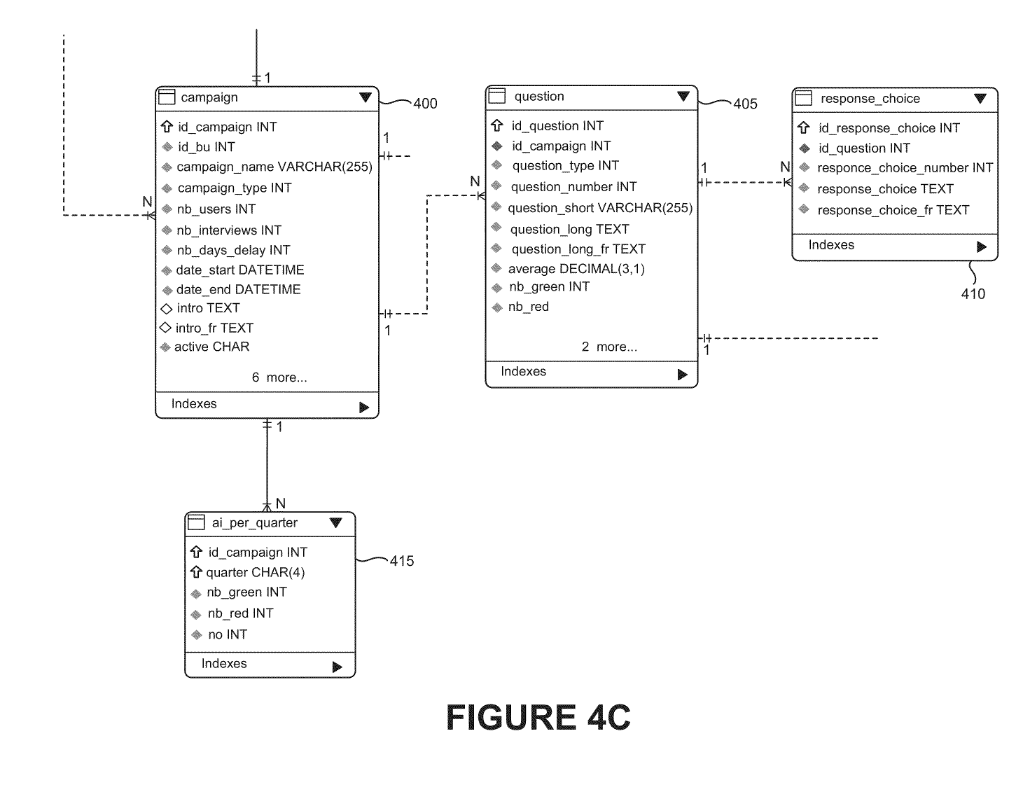

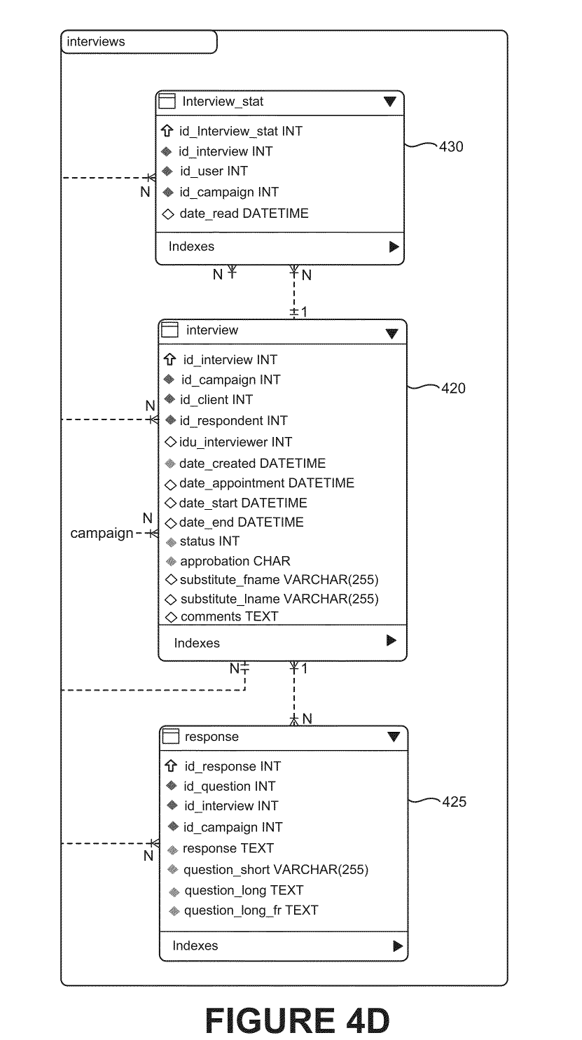

In this particular example, the database 115 is a MySQL database and comprises plurality of MySQL tables, shown in FIG. 3. The tables comprise one or more entries or rows which contain data which may be in the form of fields. FIG. 4a-FIG. 4d, illustrates the categories of data in more details, and shows more detail for the tables, including a list of some fields. The fields may include one or more primary fields which are generally shown at the top of the fields with a light oblong icon. The fields may include one or more secondary fields, shown in the list with a dark diamond icon and generally—though not always—next under the primary field(s). When a secondary field comprises a primary field of another table, this gives rise to an interrelation between the two table, often shown in FIG. 3 by a connecting line (although for clarity, not all interrelations are shown by a line) typically with a 1:N cardinality. The secondary fields in this example are relationship fields indicating a relationship with another table, as described in more details herein. The fields may also include tertiary fields, shown in the figures with a light diamond icon, which comprise data for the entry.

FIG. 4a is a blow-up of the user category 305. User category 305 comprises a user data set which comprises user profiles. The user profiles are tiered in that they are organized into tiers, in this example discrete tiers, that are associated with functions performed on the operational data. While individual users may have associated access rights to the operational data, entire tiers may have functional assignments dictating not only what type of data they may access, but also function to perform on or with the data.

The user category 305 comprises a user table 325 which has an entry for every user profile. There are also tables for the various tiers which comprise an entry for every user profile of that tier. In this example, a first user tier of users is the manager tier. Manager table 330 comprises a list of all the manager tier user profiles. The representative table 340 comprises a list of all the representative (rep) user profiles. In this particular example, there is also a vice president (VP) tier, a business unit administrator (bu_admin) tier, a license administrator (license_admin) tier, and an interviewer tier each with respective tables, namely a bu_admin table 350, a VP table 345, a license_admin table 355, and an interviewer table 335.

Some of the relationships between tables are shown by way of lines in the figures which are accompanied by cardinality indicators. Taking the user table 325, for example, this table comprises data on all the users of the system 100. However, users may correspond to entries in other tables. For example, in this particular example every user has an entry both in the table of its tier and the general user table 325. This relationship is illustrated by the lines connecting the tier-related tables with the user table 325. The lines also show cardinality. In this particular example, every user belongs only to one tier. Thus for any one particular user, there will be one entry in one of the tier-related tables and there will be one entry in the user table 325. This 1:1 relationship is illustrated by the numerals on either end of a connecting line. Where one entry in a first table may correspond to multiple entries in a second table a 1 is shown on the side of the first table and an N is shown on the side of the second table to illustrate the 1:N relationship. When a first table has multiple entries corresponding to one in a second table (an N:1 relationship) and multiple entries (but not necessarily the same number as for the second table) corresponding to in a third table (an M:1 relationship), the letter M is used instead of N to illustrate that the cardinalities N and M need not be equal.

As can be seen, a particular user profile will have corresponding data in multiple tables. As such, the user profile in this example is not defined by a single entry in one table. Rather its definition is spread across multiple tables. The field categories that are common to all user profiles are defined in the user table 325, while tier-specific fields are defined in the tier-specific tables. Moreover, additional tables may hold relational information on user profiles. For example, the representative_manager table 360 links manager-type user profiles with representative-type user profiles. In this example, representative-type user profiles are linked to a manager-type user profile to parallel the manager-rep relationship. In order to account for the possibility that one representative may report to multiple managers, and that managers each may have multiple representatives under them, the representative_manager table 360 contains a list of all the representative-manager relationships with one entry for each manager for each representative.

In alternate embodiments, the representative_manager table 360 may not necessarily be present. For example, in embodiments where representatives profiles are each associated with only one manager profiles, a simple N:1 relationship between the two may replace the representative_manager table 360. Alternatively, if each manager is precisely in charge of one business unit and therefore the manager profiles are associated with one business unit, its relationship with the business unit table 375 (which, itself has relationships with representative) may replace the link to the representative table 340 (to form an indirect relationship with the representative table 340).

The user table 325 comprises various fields pertaining to each user including in this case, first and last name fields, a login ID field, a password field, an e-mail field along with other fields. The user table 325 may also have a field for storing an encrypted portion of a token that may be generated by the server 110. Data that belong in fields that are not common to all tiers of users may be stored in the tier-specific tables. For example many tiers have an alert field indicating alerts pertaining to these user profiles.

The operational data is made up in this example of the other three categories: the interview campaign category 315, the interviews category 320 and the business category 310.

The business category 310 comprises data pertaining to clients and business organization. For clarity, the company or entity using the present technology to improve or monitor performance will be referred to herein as the “business” while the companies or entities in relation to which performance is being monitored (that are being or may be interviewed) will be referred to as “clients”. In a typical case, this technology is B2B and the business and the clients are both companies.

The present technology, in the current example, may be offered to a plurality of businesses and the database 115's data is organized so as to accommodate multiple businesses. A company table 380 comprises a list of all the businesses using the system. A business may comprise different business units among which its clients are divided. A bu (business unit) table 375 comprises entries for each business unit of each business; as FIG. 3 and FIG. 4b show, the bu table 375 has a relationship with the company table where the cardinality is N:1 since every business unit belongs to a business but there may be multiple business units in any given business. The business category 310 also comprises a client table 395. The client table comprises a list of all the clients in the system, and links them to their respective business unit with an N:1 link to the bu table 375 (since every business unit may be responsible for multiple clients) and to respective representatives entries in the representative table 340. Representatives are entities that have responsibility towards one or more client. Typically representatives are salespeople, company reps, contracts or other individuals who have contact with the clients. Since representatives may have more than one client, the cardinality between the representative table 340 and the client table 395 is 1:N.

The entries in the bu table 375 comprise fields identifying and characterizing the business unit, such as a field for the business unit's name and fields for the business unit's coordinates (address, etc. . . . ) and contact information.

The licence_admin table 355 and license table 385 pertain to licensing of the overall system 100 and will be discussed in more details further herein.

The client table 395 comprises fields relating to the client. The system 100 organizes execution of client interviews and to this end, the database 115 comprises a respondent table 390 which comprises entries corresponding to individual respondents to be reached for interviews at each clients′. Thus the database 115 may also comprise respondent profiles. There may be more than one respondent per client. In this example, each entry in the respondent table 390 comprises a field indicating the name of the respondent, fields containing contact information (e.g. phone number and e-mail address), a field indicating the language of the respondent, as well as other fields.

Returning to the user category 305 shown in FIG. 4a, as described, the user data comprises user profiles that are tiered. The representative user profiles correspond to representatives that typically have interactions with clients. Manager user profiles correspond to agents of the business, typically managers, that have managerial duties over the representatives and/or events (e.g. sales, deliveries, consulting, etc. . . . ) which are the objects or triggers of reviews.

The user data also comprises interviewer profiles, which correspond to interviewing agents who perform telephone interviews with the clients, and more specifically in this case with the client's respondents. Interviewers are typically external interviewers not operating within the business' premises or payroll. External interviewers may be working with the entity providing the system 100, or may be from an external polling or surveying company. The interviewer profile in this example corresponds to a particular interviewer at a particular interviewing system 130, although in alternate embodiments, the interviewer profile may be shared among several individuals working together for example in a polling or surveying company.

In any given business, there may be vice presidents or other high-ranked individuals who have supervisory activity over the entire business or segments (e.g. business units) thereof. In this particular embodiment, a VP tier of user profiles exists for such individuals. The system 100 provides access to VP's to information about performance, such as interview results, for the section of the business under their authority (in this example, a business unit or the whole company) but also to information on system usage, such as whether representatives are consulting the interview results for their clients and whether managers are selecting clients to be interviewed and consulting the results. This allows a “VP” (so named for convenience, but not intended to be strictly limited to individuals having the title of “vice president”) to go in at any time and review performance.

For example, if sales are dropping in one sector of the business, a VP may choose to consult what the client interviews results are in that sector to see identify a particular source of discontentment or a reason for the decline. For example, if clients are citing a cheaper competitor, or an alternative product, the VP may then formulate a strategy to match prices, or otherwise address that particular competing pressure. On the other hand if clients are citing a discontentment with their representatives, the VP can then review the nature of the complaints and address the issue with appropriate remedial actions such as re-training. Moreover, the VP can also consult whether the system 100 is being used effectively by the member of his organization by being given access usage data showing, for example, whether a representative is reviewing his clients' interview results. Thus the system 100 provides VP-tiered individuals with a tool not just for tracking the performance of the business but also of individuals within the business and can provide useful intelligence for example during annual performance reviews.

VP's belong to the business and there may be several VP's in any given business, hence the 1:N cardinality of the business-VP relationship. VP profiles may be associated with one or more particular business units. Similarly, business units may be associated with more than one VP. For this reason, a VP_BU table 365 is provided that tracks the relationships between VP's and business units.

FIG. 4c shows details of the campaign category 315. The campaign category 315 comprises a data set comprising data providing parameters to one or more interview campaigns. A particular interview campaign profile comprises a set of questions, some of which may be multiple choice questions. Campaign data from the campaign profile, including at least the questions and multiple-choice answers, if any, are provided to the interviewers to be followed in the telephone interviews.

A campaign table 400 comprises entries for each campaign. As mentioned, the system 100, may be used by more than one business and each may have tailor-made interview campaigns suited to their particular field of endeavor. Moreover, a particular business may choose to run multiple interview campaigns. For example a business may have different campaigns for different types of clients (e.g. clients buying hardware solutions vs. clients buying software solutions) or a business may choose to have an “initial campaign” for a first round of interviews with clients and have a “follow-up campaign” whereby a different set of questions are asked the second time a client is interviewed. This may be useful, for example where unsatisfied clients are selected for re-interview a certain period of time after the first interview (e.g. after the next “event” or interaction with the representative, or after a preset period of time, or at a later time of the manager's choosing) with the follow-up interview having questions focusing on whether the client's previous concerns where addressed.

Thus the bu table 375 and the campaign table 400 have a relationship with a 1:N cardinality. The campaign table has fields comprising data for the campaign. Not all the fields of this example are visible in FIG. 4c. The campaign table comprises fields including a textual field with instructions to the interviewer and may include, for example, an introduction to read out when the interviewer presents himself/herself over the phone.

The question table 405 contains the interview questions. Every question belongs to a campaign and for any given campaign 400, there may be a number of questions (though typically as few as two in this example) hence the 1:N cardinality between the campaign table 400 and the question table 405. Questions may be open-ended (e.g. “what would you change about our service?”) or may be multiple choice. For each entry of a multiple choice question, the response_choice table comprises entries for each possible response choice, hence the 1:N cardinality. An example of multiple choice questions may be “Would you recommend us to a friend?” which may be associated with the response choices “yes” and “no”. Another example of a multiple choice question may be “On a scale of 1-5, how satisfied are you with our services?” which may be associated with the response choices “1”, “2”, “3”, “4”, and “5”.

The ai_per_quarter table 415 is an administrative table which stores counters that are updated in real time to provide live statistics. In this example, the table comprises entries for each quarter for each campaign which have fields counting the number of responses that are considered positive by a given metrics and the number of responses that are considered negative by a given metrics, and the number of responses that are considered neutral by a given metrics.

Returning to the user category 305 shown in FIG. 4a, a campaign_interviewer table 370 serves to link interviewer profiles with campaigns. Like with the representative_manager table 360 and the VP_BU table 365, interviewers 335 may each be associated with more than one campaign from the campaign table 400 and campaign entries in the campaign table 400 may each be associated with more than one interviewer entry from the interviewer table 335. The campaign_interviewer table 370 comprises a list of relationships between interviewer table 335 entries and campaign table 400 entries.

FIG. 4d shows the interview category 320. The interview data in the interview category comprises data on scheduled interviews, interviews that are under way and interviews that have taken place. The interview table 420 comprises entries for each interview: past, present, and scheduled and is linked to a particular respondent from the respondent table 390, although respondents may be linked to multiple interviews, for example if there are more than one interview campaigns to which they are respondents. A particular interview campaign, will typically comprise a plurality of interviews, e.g. one for each client of the business, or in this particular example up to a certain preset number of interviews for which the business has paid for. Yet the interviews all belong to a campaign hence the 1:N cardinality of the campaign-interview link. An interview table may be created when an interview is scheduled, which may be as a result of input from a manager profile, as described in more details herein. In the interview table 420, entries may have several fields, including a status field comprising a flag indicating whether the interview is scheduled (to do), done, or being done (underway). The interview table in this example also holds fields indicating the respondent, shown also as the link with the respondent, and may include schedule data, such as fields for start and end dates between which the interview must be undertaken, as well as substitute respondent fields which may be populated with data on an alternate respondent if the intended respondent is not reached. This field may provide a secondary respondent, or may be available to be filled by an interviewer if the interviewer could not reach the respondent (e.g. because he no longer works for the client being interviewed) and had to speak to someone else.

Corresponding to each interview in the interview table 420 will be a set of responses found in the responses table 425. These correspond to the questions from table 405 of the particular campaign of the interview. Although there may be more than one response per question, there is typically one. The responses are provided by the interviewers e.g. in the manner described further herein. Redundant links are not shown in the Figures, but responses from the table 425 also are linked to the campaign of the interview.

An interview_stat table 430 logs accesses to interviews by users, e.g. by representatives. When a user, e.g. a representative profile accesses a particular interview, an entry corresponding to that interview is created in the interview_stat table 430, which in this example comprises merely a date and time field logging the access. Later accesses are also logged by creating new entries in the intervview_stat table 430. In this manner it is possible to store data on the usage of the system 100. This also allows, for example, visual indications on remote devices 120 that a new interview has not been viewed yet.

The description provided of the database 115 is an exemplary one provided in the spirit of illustrating and not limiting the present technology. Other types of databases may be used and may benefit from the data organization scheme and hierarchy, if not the exact form, described herein.

As illustrated in FIG. 2, the server architecture 105 of this example comprises a router module 160, in this example implemented using Express.js and server operational logic 165 in an AngularJS framework. The server operational logic 165 comprises a set of functions for accessing the database 115 and performing operations on the data therein. These functions may be called by the router module 160 with arguments provided by the router module 165 obtained from communications with remote devices 120.

Herein, communication between the server architecture 105 and remote devices 120, will often be described as communication with user profiles, rather than with users themselves. This is because while the remote device 120 typically has a user operating it, in this implementation the server 110 authenticates not the physical users themselves but rather their credentials which are linked to a user profile. Thus the server 110 authenticates the user profile and as far as it is concerned, it is not communicating with a particular user but rather the user profile which corresponds to concrete data it has stored.

According to this particular example, the router module 165 parses incoming requests which follow the REST API, and more specifically the URI from an incoming request and formulates a function call with it. A typical function call for this particular example may have the following form:

router.get(‘/abcdef’, [tokenAuth], fndir.fnname);

where ‘/abcdef’ is the particular request as found in the URI provided by the remote device 120, [tokenAuth] is the token, or a portion thereof, associated with a user profile, and fndir.fnname is the function to call, which in this particular case comprises a function directory (fndir) and a function name (fnname).

The server operational logic 165 may comprise a set of functions related to the user data set. These functions may be callable as a result of requests from users, but not necessarily from all users as some different tiers of users have access to different functions.

The function of the various remote devices 120, and of the real-time performance monitoring system 100 as a whole will now be described with reference to specific examples.

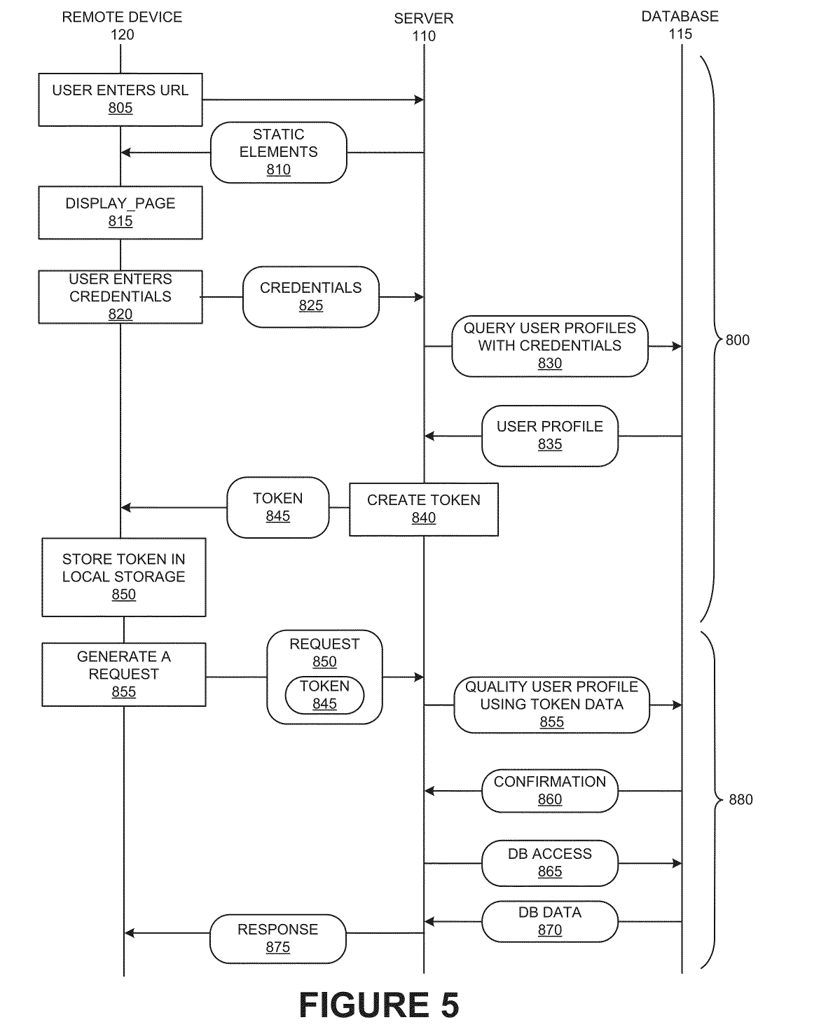

FIG. 5 shows an event flow diagram of the login interaction 800 and an exchange 880. When a user of a remote device 120 wants to access the system 120, the user may, at step 805, open a web browser and enter a URL which directs it to the server 110. The server receives a first request from the remote device 120, which may include a request to load static elements of the page and, in this example, device operational logic 150, for example JavaScript or other logic instructions. The router module 160 receives this request, and recognizing the static elements requires services it itself without, in this implementation, calling any functions from the server operational logic 165, by loading the appropriate static elements 810 and returning them to the remote device which initiated the request. The browser loads these elements and displays the page at step 815.

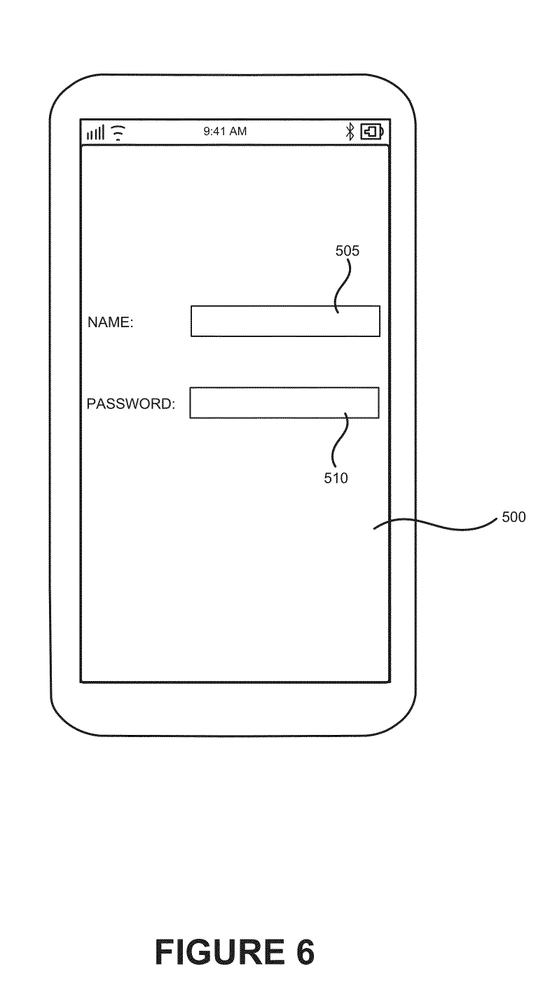

FIG. 6 shows an example of a first page loaded onto the browser window of the remote device 120, which is a login screen 500 comprising an input prompt and an input tool, in this case a username textbox 505 and a password textbox 510.

In this particular example, the system 100 employs a token based security protocol to safeguard communications between the server architecture 105 and the remote devices 120. It is to be understood that other security measures may be used in addition to or instead of the token based protocol, however in the spirit of providing a complete disclosure the present example will be described. The user of the remote device may then enter the credentials 825 for the user profile at step 820, which in this example comprise a username and password. These are sent to the server in a communication which may be encrypted using asymmetric public key encryption.

The server architecture 105 has access to the user data. In this particular implementation, upon receipt of the user's credentials, the server 110 queries 830 the database 115 using the credentials 825 to ascertain whether there is a valid user profile corresponding to the credentials 825, and to ensure that the password provided is correct. The user profile is found in the database 115 and user profile data, which may include, for example data from the user table 325 and/or data from a tier-related table such as the manager table 330, is obtained from the database 115.

At step 840, the server operational logic 165 causes the creation of a user token 845, which comprises in this example an encrypted portion and an unencrypted portion. The non-encrypted portion comprises identifying information for the user profile such as credentials 825 (or a portion thereof) while the encrypted portion comprises other identifying information (which may include credentials 825 or a different portion of credentials 825). In this example, the encrypted portion is encrypted using a symmetric encryption scheme with a key that is only known to the server architecture 105, and more particularly in this case the server 110. The token 845 is returned to the remote device 120. The transmission of the token may be done in an encrypted manner using an asymmetric encryption scheme, e.g. with a public key that was provided with credentials 825.

Upon receipt of the token 845, the token 845 is stored at the remote device 120 in a local storage to be used in future communications with the server architecture 105, and more particularly here with the server 110.

Going forward, communication with the server 110, such as exchange 880 use the token 845. In a generic example, the remote device 120 under instructions from the device operational logic 150 generates a request 855 to the server 110, which request requires database access. In this example, the request is provided by an http packet comprising a URL which identifies the server and a particular action or function requires and which includes the token 845 in the header. Other details and parameters of the request may be provided in the packet and packet headers.

The server 110 receives the request 850 and the router module 160 and parses it and recognizes the need to call upon a server operational logic 165 function and prepares a function call to the server operational logic 165. In this particular example, the validation of the user profile associated with the request is done as part of the functions called. Thus as a first step in the execution of the function which comprises access to the database 115, the encrypted portion of the token 845 is decrypted to ensure a match with the unencrypted portion and the database 115 is queried 855 using the token 845 to validate the data in the token, in particular the user profile associated with the request 850. The server 110 derives from the database 115 a confirmation 860 of the user profile. Upon validation, the server operational logic 165 moves on to the particular database 115 access required by the request and makes a database access 865, which in this particular example retrieves from the database 115 database data 870. The function then prepares a response to the request 850 using the database data 870, which the router module 160 then transmits back to the remote device 120.

When a business first decides to employ the system 100, an administrator at an administrator station 140 may implement prepare the system 100 for the new business. The administrator employs a license administrator (license_admin) user profile which is provided with functions and access to the database 115 by the server 110 to enter into the database 115, data on the new business.

To being with, the administrator may log in to the system as described above using a license_admin user profile's credentials. In response the server 110 may provide the administrator computer with device operational logic in the form of administrator operational logic to implement a program specific to the license administrator profile, which includes functions specific to license administrator profiles and a graphical user interface specific to license administrator profiles. The graphical user interface may be implemented, e.g., in a browser window and may provide the administrator with a variety of options by way of graphical user interface tools.

In this particular example, the graphical user interface implemented on the administrator station 140 by execution of the administrator operational logic comprises a tool for adding a new business to the system, which in this example is provided by means of a clickable “add new business” button.

Clicking this button will cause the display of a “new business” form as implemented locally by the administrator operational logic in this example. The new business form comprises a plurality of input tool in the form, in this example, of fillable fields for providing the data that will be added to the database 115 by populating in this example the tables described herein. The form may include fields for providing data on the business itself, including the data that will populate the fields of the company table 380. The form may also include fields for providing data on the business units of the business, including data to populate the bu table 375.

The form may also include fields for providing some or all the users of the business, including data on some or all the user profiles. This may include data to populate the user table 325, the manager table 380, the VP table 345, the bu_admin table 350, and the interviewer table 335. This may also include data on all the representatives to populate the representatives table 340, although this data may also be provided in some implementations by an administrator profile.

The form may also include fields for defining an interview campaign either by selecting an existing campaign or by providing all the information for a new campaign, including a list of questions and multiple choice responses. The campaign table 400 may also store information on other aspects of the campaign. In one embodiment, the system 100 is purchasable by business according to different packages featuring parameters such as numbers of interviews available per period of time (e.g. week), total number of interviews available, time period for the campaign, minimum interview delay between interviews for a same client, number of questions (and, possibly, number of multiple choice questions or number of open-ended questions). These parameters may be provided, in this implementation by the license administrator profile and stored as fields in a campaign entry in the campaign table 400 (although the number of questions merely indicated by the cardinality of the questions in the questions table 405 that correspond to the campaign).

When the administrator has completed the form, the administrator activates its transmission using a graphical user interface tool provided by the administrator operational logic, in this example by clicking a “send” button, and the administrator device 140, under instruction from the administrator operational logic, generates a request which it transmits to the server 110. The request in this example will include the data entered and an indication that this data is to be provided to the database 115 to register a new business.

For its part the server 110 will call up the appropriate function. In this particular implementation the router module 160 will receive the request, parse it and call up the appropriate function or functions. In this example, the server operational logic 165 may comprise a set of functions to create a new license which may be called up. More specifically in this non-limiting example, the server operational logic comprises the following functions:
A licenses.add function to create a new license with parameters provided
A companies.add function to create a new company with parameters provided.
A bus.add function to create a new business unit with parameters provided. For multiple business units, this function may be called multiple times.
A campaign.add function to create a new campaign with parameters provided.
A question.add function, which may be called multiple times to add each of the questions provided.
A questions.addRc function, which may be called multiple times to add multiple choice answers for each multiple choice question.
A users.add function to add a user which may include adding an entry with data provided in the user table 325 as well as in other tables such as in the corresponding tier-related table. This function may be called multiple times for adding multiple users.
There may also be an overarching function in the server operational data 165 administrating the calling of each of these functions based on the request received.

In alternative embodiments, instead of sending a single request with all the information, requiring an overarching function, the administrator operational logic may cause individual requests to be sent corresponding to each function to call. Since in our example the administrator operational logic is determined by the providers of the system 100 (specifically, it is provided to the administrator station 140 by the server 110), this logic may be designed to match the server's functions. The administrator operational logic may also present prompts to the user for input in an order matching the individual requests, or it may itself comprise an overarching function that breaks down the contents of a single form (as above) into individual requests.

A license identifier may be provided as part of tokens used by communications with user profiles, and particularly in the encrypted portion of the token, which allows the filtering of database 115 accesses using the license which is associated with the user profile.

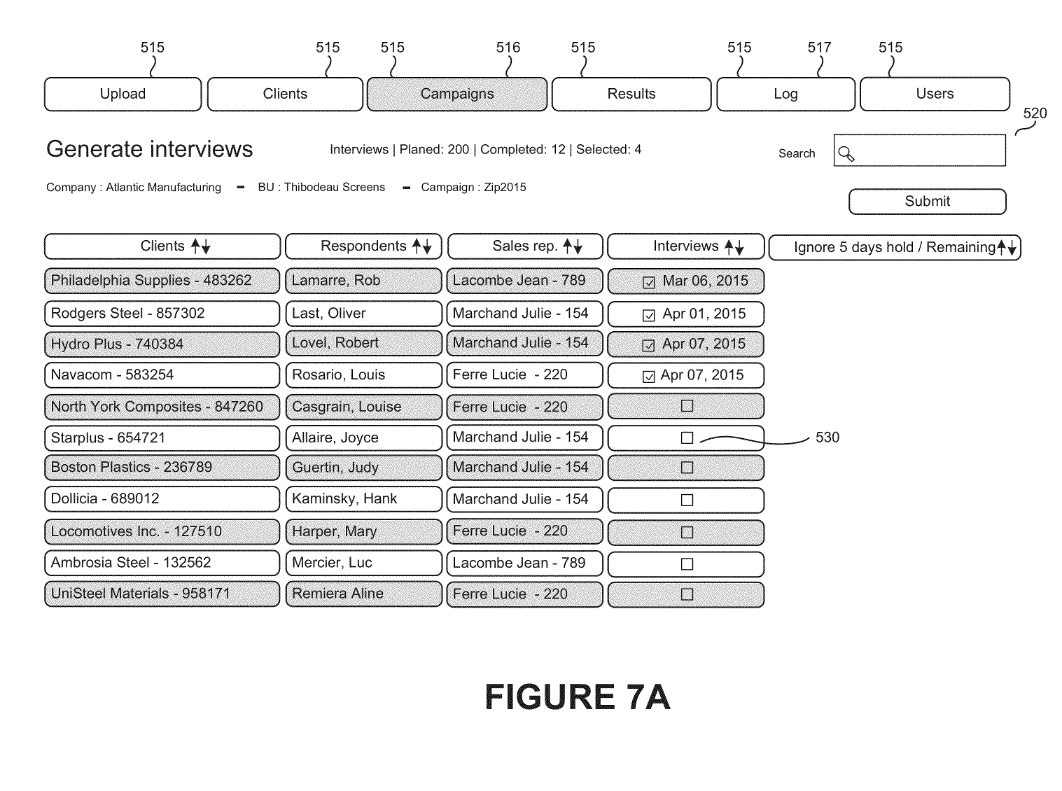

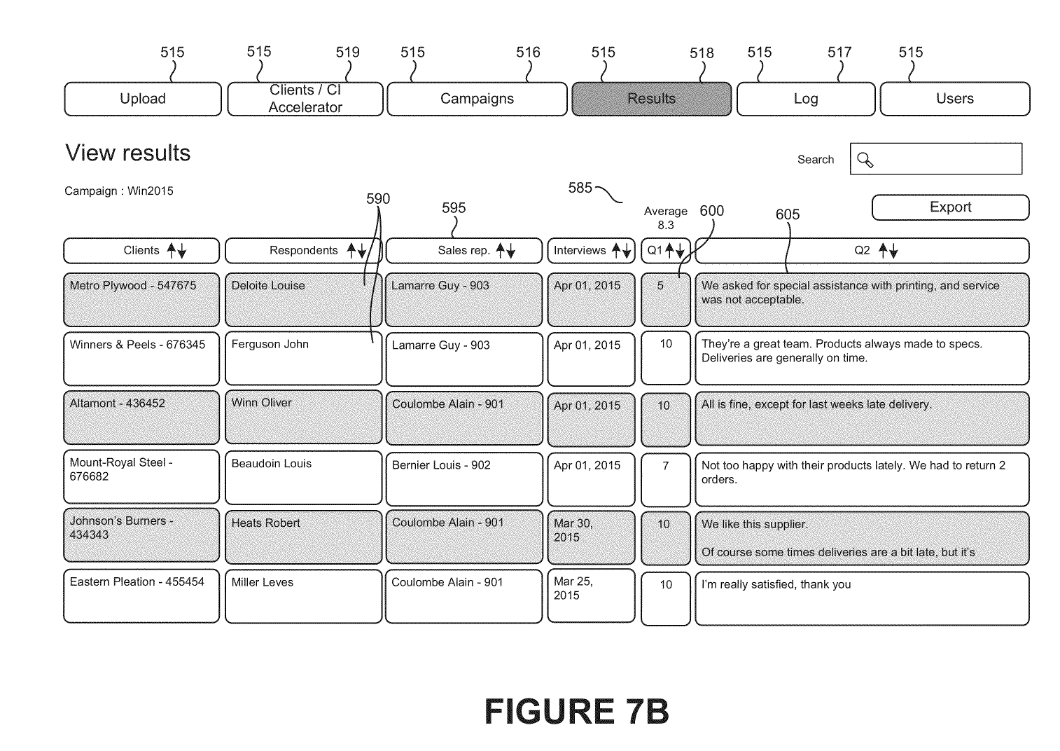

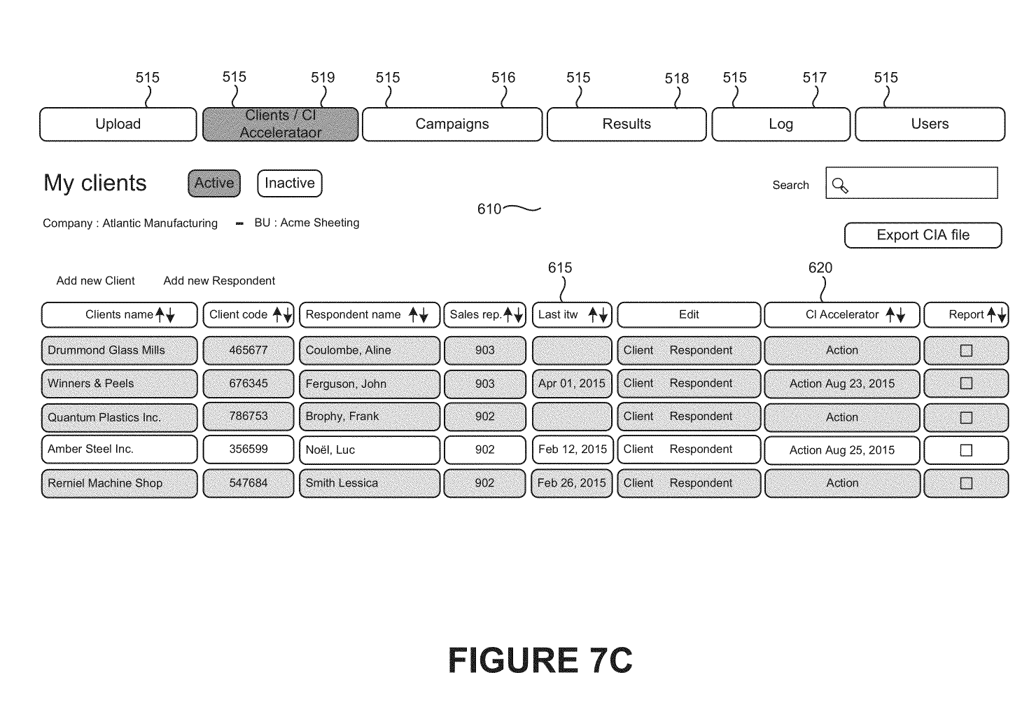

An exemplary implementation of a manager computer 125 will now be described with reference to FIG. 7a-FIG. 7c.

Manager user profiles have access to the interview results related to representative user profiles associated with them. In practice, this generally means that managers can see the performance of the representatives that they manage. However, manager user profiles have other functions which give them a measure of control over interview campaigns and client lists.

Like with other remote devices 120, the manager computer 125 has its own local storage and has device operational logic, in this case manager operational logic. In this implementation the manager operational logic is stored in the local storage, and comprises computer-readable instructions instructing a processing entity in the manager computer 125 to perform the functions described herein. In this particular case, the program instructions are loaded from the server 110 as described herein.

Among the static items loaded from the server 110, besides JavaScript, are pages (e.g. provided using html code) which together with the functionality conferred by the script, present to the manager user a graphical user interface. These are loaded following a login procedure as described above. Based on the credentials 825, the server 110 knows that the particular user profile behind the request is a manager profile and therefore provides the appropriate static items including the appropriate device operational logic, if necessary.

The graphical user interface may have multiple panes for presenting different types of information. In the example provided here, tab-like buttons are provided to allow a user to navigate through the panes. In this particular embodiment, these clickable button give rise to a request for the static items of the corresponding pane if it has not already been loaded and cached, and the manager operational logic generates a request and causes it to be transmitted to the server 110 accordingly. In alternate embodiments all of the panes may be preloaded and/or present in the manager computer 125's local storage.

FIG. 7a illustrates the graphical user interface provided at the manager computer 125 with a campaigns pane 520 presented. In the present example, the manager's business has purchased a plan with the system 100 which includes an interview campaign lasting 24 weeks, during which they may order a maximum of 240 interviews, but no more than 20 in any one given week. Corresponding data is provided in the operational data of the database 115. In this particular example, plans are purchased on a per-business unit basis and these parameters are stored as field's to the business unit's entry in the BU table 375. In alternate embodiments, plans may be provided for an entire business unit, and accordingly these parameters may be stored in the company table 380, with optionally additional parameters per business units (e.g. per-BU limits) in the BU table 375.

According the present implementation, the system 100 provides businesses the control over which client gets interviewed when. This makes of the system 100 a tool for businesses to measure performance in targeted and relevant ways. For example, if the business has a promotional campaign in a certain sector, the clients affected may be selected for interviewing to gauge the effectiveness of the promotional campaign. Alternatively, it is particularly useful for the business to be able to select clients to interview soon after having undergone an event such as an interaction with a representative, a sale, consulting, etc. . . . in order to obtain their feedback while the memory of the event is fresh and to therefore get the most pertinent feedback.

When the user clicks on the campaigns button 516, the manager operational logic generates and sends a request to the server 110, containing the token and requesting a list of all the clients for the particular manager profile. The server operational logic 165 may comprise, in this particular implementation, a clients.findAll function which first validates the token and finds the user profile associated with it in the database 115, then accesses the database 115 to identify all the clients for the manager profile's particular business unit, returning only the clients that are so associated with the manager profile. These are provided to the manager computer 125 in a response from the server to the request containing the client data. Besides data from the client table 395, the server operational logic 165 may also retrieve other elements of a client profile such as one or more respondents. The server operational logic 165 may also retrieve the representative associated with the client. These may similarly be provided in the same or additional responses to the manager computer 125. In the campaigns pane 520 comprises a campaigns table a list of all the clients associated with the particular manager profile that were received is displayed showing details that were provided by the server architecture 105. In particular, the list indicates the name of each client, a respondent associated with the client, and the representative associated with each client.

The clients are arranged in rows 525 and in each row 525, there is a tool, in this case a checkbox 530, which allows the user select which clients are to be interviewed in the coming week. In this particular case, since the business has a maximum of twenty interviews per week, if twenty boxes are checked the manager operational logic will cause the remaining check boxes to become grayed and uncheckable until some checkboxes become unchecked.

Upon checking a checkbox, the manager operational logic generates a request, which here is an interview request, which it transmits to the server 110, comprising an indication that the client is to undergo interviewing. Upon receipt at the server 110, the operational logic 165 accesses the database 115 to modify the operational data to create in it an indication that the interview is to be conducted.

The database 115 thus may comprise indications that interviews are to be conducted. For example, the entry for a particular client in the client table 395 may comprise a flag indicating whether an interview is to be conducted. However, in the present implementation, there may exist more than one interview campaign corresponding to a particular client. This may be accounted for by providing an indication of a campaign for which an interview is to be done, e.g. by providing as the flag a variable indicating a particular campaign. In the present implementation, however, the interview entries in the interview table 420 correspond typically to a particular client and there is only one entry per client per interview. Therefore, the interview table 420 is a good place to create an indication that an interview is to be conducted. To this end, the interview entries may include a flag or other indicator indicating whether an interview is to be conducted. Alternatively, if the interview entry is created only when the interview is requested by a manager (e.g. in response to the request sent upon checking the interview box), then the presence of an entry corresponding to an interview (which corresponds to a campaign and a client, and therefore indicates which client is to undergo an interview, and also in this case which interview campaign) may itself be the indication that an interview is to be conducted. In the present example, the interview entry is created upon receipt of the request for the interview, but the table 420 also comprises a status flag which indicates the status of the interview. In this example the status' value may be a value representing “to do”, a value representing “under way” or “being done”, or a value representing “done” or “completed”. Thus the presence of the interview entry as well as a flag associated with the entry both serve as indication that the interview is to be conducted. In the absence of an interview entry for a particular client, it may be concluded that no interview is to be conducted which if an interview entry exists, the flag further indicate whether the interview is to be done. Creating an indication that an interview is to be conducted may thus comprise setting a flag or value in memory, or creating new data, such as a new entry in memory.

Typically, the manager does not have control over the interviewer that will be assigned to the interview (though in an alternate embodiment, this level of control could be provided) but rather, the license administrator assigns an interviewer profile or profiles to the particular campaign or business. When the interviewer logs on, he/she will see the new interview in his list of deliverables.

Optionally, the server operational logic 165 may comprise a function run on a scheduled basis (e.g. once a day) that searches through the database 115 for interviews to be done and generates a communication (e.g. an e-mail) to the interviewer indicating that he/she has a new interview to do.

Moreover, the campaign may include parameters for automatic selection of clients. The ability to monitor client satisfaction in real time is very useful and appealing to many managers, however it isn't a given that all managers will always have time to log into the system regularly. Nonetheless, when they are not fully engaged with the system, they may still want the system to work, even absent their explicit input. For this reason, in this particular example a default scheduling mechanism is provided that allows automatic selection of clients for interview in the absence of input from manager profiles. In particular, the campaign table 400 comprises for its entries fields indicating default number of selections (e.g. 10 per week). On a regular interval (e.g. once a week) a scheduled function in the server operational logic 165 goes through the operational data and assess how many interviews have been selected/created for each business or business unit, and if a lower number than the default number of selections is selected, it selects the difference from among the remaining clients. These selections appear checked in the client list on the campaign pane 520 the next time the manager opens it.

According to the present embodiment, clients may be interviewed multiple times in a particular campaign. There may therefore be multiple interviews for any given client and corresponding interview results. Each interview for a client may have taken place at a different point in time, allowing an evolutive performance tracking/monitoring such that improvement efforts may not only be informed by the system 100, but the system 100 also provides an improvement evaluator whereby the effectiveness of improvement efforts are be quantified by the changes in results for given client(s) over time.

As described a manager profile can provide the selection of clients to interview, which may include clients previously interviewed. However, an automatic selection function of the server operational logic 165 may implement an automatic re-evaluation of a client by automatically selecting clients previously interviewed for subsequent interviews. The automatic re-evaluation may be random if the automatic selection function comprises a random client selection, or may be ordered, if the automatic selection function automatically selects clients to interview based on an order (e.g. alphabetically selecting every client once, continuing down the list, ignoring de-selections and selection from a user except that if a client was manually selected less than a minimum interview delay period ago then it is skipped, and looping back to the top of the list when the bottom is reached).

In one example, however, the automatic selection function comprises an intelligent selection algorithm that favors selection of clients according to an order of preference. In one example, the algorithms favors clients that have not been interviewed yet (e.g. in order as above or randomly) first, followed by clients that have had a low score (e.g. according to a threshold or according to a deviation from an average which is computed), followed by clients that had a good score (likewise e.g. according to a threshold or according to a deviation from an average which is computed), followed by the remaining average clients again in an order or randomly. Another example of a preference order would be clients that have not been interviewed followed by clients that had the lowest interview scores and moving up to the clients having the best interview scores.

A preference order can take into account other factors such as how recent the last interview was. In one example, any the above algorithms is supplemented with a rule that if a client has not been interviewed in a predetermined period of time (or at all) it automatically gets highest preference. In such a case, the rule makes the preference for uninterviewed clients redundant. Another example of a rule would be that any client that been interviewed but not in a predetermined period of time is automatically promoted to second-highest preference level after those who have not been interviewed at all.

A preference order can also take into account other factors such as whether the previous results have been consulted by the representative or another user (and, e.g., prevent an interview from being undertaken with a restriction like the minimum interview delay until the results have been consulted, give the client a low preference level until the results have been consulted) and/or the date of the consultation of the previous results. Indications of interest in the results from other users such as from a VP user (deducted, for example, by the consultation of the results by the VP or by an input from the VP (and corresponding request to the server architecture 105) indicating interest) may also be taken into account to inform a preference level, in this example to increase it.

Likewise as the interviews are conducted and the status changes from “to do” to “done”, the checkboxes become unchecked (this is discovered by the manager operational logic when the request for clients prompts a response generated by the server showing not only client profile data but also interview data including scheduled interviews (which it presents in the form of checked boxes) and past interviews (which it presents in the form of a date indicating the date of the last interview)). As mentioned, the campaign data may specify a minimum amount of time between interviews of a same client. If an interview has been completed in less than the minimum wait time, the operational logic may cause the checkbox for that interview to be grayed and uncheckable.

The automatic selection of clients to interview may be performed at random, or may be based on other factors such as in order time since the last interview (the least recently interviewed first). In one non-limiting embodiment, the server operational logic 165 may comprise an event trigger which monitors certain events and schedules interviews accordingly. The event trigger may be built into the existing functions (if triggered by events affecting other functions) or may be a separate function, e.g. run on a scheduled basis. One example of a trigger may be the addition of a new client. The event trigger may cause this client to be automatically selected for an interview. In other alternate embodiment, the event trigger may be linked to other sources of information, e.g. a company schedule or a sales roster, and cause interview triggering based on occurrences as ascertained from the other sources of information.

As described the operational logic provides the user of the manager station 125 with a list of clients including checked boxes on those selected for interviews, regardless of whether the user himself/herself checked it or if they were checked by the automatic selection capabilities of the system 100 (optionally an indicator may indicate the source of the selection). Once logged in, the manager may see what has been selected and change the selection by unchecking boxes and checking other as he/she sees fit. Upon an unchecking of a box the manager operational logic generates and transmits a request to the server 110 to cancel the interview. The server operational logic 165 may have a interviews.cancel function which has an interview identifier as parameter. In the present example, this function verifies the token of the requestor for validity, tier and permission and cancels the indicated interview. It may do so by changing the status of the interview in the interview table 420 to an “not selected” (or “not to be done”) status or by deleting the interview entry in the interview table 420 altogether.

The campaign may specify a deadline for doing interviews from the date of selection (e.g. one week) which may be stored as a value in the interview's entry in the interview table 420. Optionally, the manager operational logic may also include logic to receive input indicative of a deadline and provide that deadline as a field in the interview's entry in the interview table 420.

In addition to the campaign pane 520, the manager computer 125 may be presented a results pane whereby past interviews are listed and can be selected to display their results. To this end, the manager operational logic may generate a request for interview data triggering at the server the calling of an interviews.findAllResults function, which with the token identifies all the completed interviews associated with that particular management profile and provides interview data in a response for display at the management computer 125. A summary view of all the results may be presented in a results pane 585, which is displayed in response to a user interaction with a graphical user interface tool, such as clicking the results button 518.

FIG. 7b illustrates the graphical user interface provided at the manager computer 125 with the results pane 585 presented. As shown each of the interviews associated with the manager profile are provided in respective rows 590 of a result table 595. In this example the interviews comprise two questions, a quantitative performance score and an open-ended comment. The results of the interviews are displayed in the result table 595 in two columns, a question 1 column 600 showing the quantitative score provided in response to the first question and a question 2 column 605 showing a transcript (or an interviewer-generated summary) of the response to question 2. Interviews campaigns with more questions, the result table 595 may comprise result summary data, either computed by from the result data by the manager operational logic or earlier by the server operational logic 165 and provided as part of the result data.

The result table 595 further comprises other columns displaying information associated with the listed interviews, including the interview date, client data (e.g. obtained and provided by the server operational logic 165 from the client table 395 in the database 115) such as a client name, respondent data (e.g. obtained and provided by the server operational logic 165 from the respondent table 390 in the database 115), and the associated representative profile (e.g. similarly obtained).

Optionally, for example in some embodiments where the complete interview results are not shown in the result table 585, clicking on a graphical user interface tool such as an associated button for one of the interviews or the text of a particular row can cause the generation of a request for result data which triggers the calling of a interview.readResults function. This function is provided with the token and an interview ID (which was received with the list of interviews) and performs a token verification for validity, tier and permission and retrieves response data from the response table 425 (and optionally question data from the question table 405 and response choice data from the response_choice table 410 to display alongside the responses) and provides them in a response to the management profile at the management computer 125 for display to the user.

Other panes similarly allow the manager to view clients, and users in his/her business unit. FIG. 7c shows a client (or “continuous improvement accelerator”) pane 610 which is displayed in response to a user interaction with a graphical user interface tool, such as clicking the clients button 519. When the user clicks on the clients button 519, the manager operational logic generates and sends a request to the server 110, similar or identical to the one described above in relation to the campaigns pane 520, which may give rise, in this example to the invoking of the clients.findAll by the server operational logic 165. The clients pane 610 comprises a clients table 615, which comprises some of the same information as the campaigns table and the results table 595. The clients table, however, may also comprise a continuous improvement accelerator (CI accelerator) row 620 which comprises information on improvement actions. Improvement actions comprise events that may be in the past, unscheduled or in the future. To this end, the client table 395 may comprise fields for each client entry pertaining to improvement actions. These may include a date field for an improvement event, and a description field which may be a variable indicating one of a choice of improvement events, but in this example is a text field comprising a written description. These are retrieved and provided by the server 110 upon a request from the manager profile resulting from the clicking of the clients button 519, either as part of the clients-seeking function (e.g. clients.findAll) or as a separate function for specifically those fields.

The clients pane also allows the user associated with the manager profile of edit clients information. By clicking on any portion of a client row (except, in this example, the “last interview” column), the user may is provided a text box to edit the value of the particular parameter of the client profile. Once done (in this example by hitting the enter key) the manager operational logic generates a client update request and transmits it to the server 110, which triggers a function at the server operational logic 165 accessing the database 115 and modifying the client profile, e.g. in the client table 395, but also in the respondent table 395 if the parameters modified were respondent parameters.

A log pane can be accessed in this implementation by clicking a log button 517. Similarly to the campaigns button, this triggers a request for static elements and database data from the server architecture 105, which will come in this example from the server 110 and the database 115 respectively. As described above, the operational data comprises log data, in this implementation comprised at least in the interview_stat table 430, which comprises information on access to interview results, and includes data indicating access to the interview results by representatives. In this particular example each time a representative accesses response data for interviews associated with his clients, the access is logged in the interview_stat table 430 as an entry. This information becomes available to managers (and also VPs) to permit tracking not only of performance but of improvement efforts as well. Likewise manager's access to interview results may also be logged and present to VPs if desired. An additional layer could be implemented to track manager's access to logs of results viewing to present to other users (e.g. VPs) the manager's improvement tracking efforts.

In the present example when a user with a manager profile clicks on the log button 517, the manager operational logic generates and transmits a request to the server architecture 105 for the log data. This request specifies the token. Although all log data accessible to the particular user may be presented, this could be inconvenient, particularly if a representative has been logging in and out of a results page and accumulated many views resulting in many redundant logs. A way to address this inconvenience would be to only log the latest view (and to replace it by subsequent views as they occur). However in the present example, the request from the management profile triggers the calling of a interviews.findAllLogs function, which despite the name only returns the logs for the management profile's tier and permission (having validated the token, see below). Moreover, as the function goes through the logs in the operational data, it keeps only one log for each interview for each representative showing the earliest date of access. This information is returned in a response to the request and displayed on the management computer 125.

As a general rule, requests to the server in this implementation involve an identification of a desired functionality, be it the function of the server operational logic 165 itself or another indication which the router module 160 or server 110 in general can translate to required functions in the server operational logic 165. The requests generally also include parameters, which generally includes at least the token and sometimes other parameters (e.g. interview ID, as above). The token is used for a request validation, which in this embodiment is a three part verification whereby the server 110 verifies the validity of the token, the tier of the user and the permissions of the user. Additional verification could also be used.

The validity of the token in this implementation is verified by decrypting the encrypted portion of the token and verifying whether its content corresponds with an expected content. This may be verified against the unencrypted part of the token or against a copy of the expected content stored at the server 110 or database 115, or both. In this particular example the unencrypted part of the token is used to pull up from the database 115 the user's entry in the user table which itself contains the expected decrypted portion which is then compared with the decrypted portion.

The tier associated with the user profile is also verified when user profile data is pulled up from the database 115. The tier be found by searching through all the tier-specific user tables in the database 115, however in the present implementation, the user table 325 comprises a field (type INT) specifying the tier of the user. Tier verification reveals what portions of data and functions the user should have access to, though not the specific data itself. For example, the management profile has access to interviews and can receive their details, create and cancel interviews and this for all the interviews associated with a business unit. Thus the management profile's request may trigger certain functions to this end in the server operational logic 165 which may not be accessible to other tiers. However, the tier itself does not indicate specific permissions such as which business unit's particular interviews may be so accessed.

The permissions associated user profile are also the object of verification insofar as the functions called to access the data will be restricted to the permissions granted to that particular profile's permissions. Permissions refer to rights of access to particular data, such as a particular interview or client. In our exemplary implementation, permissions are related to the links and cardinality between tables. For example, a representative will have the permission to view interview results as a virtue of his/her tier, but will have the permission only to view the interview results of clients that are associated with his/her representative profile. Likewise a manager has permission to view interviews and results but only those which are associated with his/her business unit.

An exemplary implementation of an interviewer system 130 will now be described.

Interviewer profiles correspond to interviewing entities, generally individuals, who are mandated to perform telephone interviews for the system 100. Interviewers may be associated with the business or with the operator of the system 100, but in the present example, interviewers are external contractors that are contracted to work campaigns. As mentioned, interviews are conducted liver, person-to-person, preferably over the phone.

Interviewers access the system 100 via interviewer systems 130, which may, like the management computer 125, be a computer that has an internet connection and a browser that is used to access the server 110 in much the same manner as the management computer 125.

Interviewer user profiles have access to the campaign data and interview data related to particular campaigns to which they are associated (in this example via entries in the campaign_interviewer table 370).

Like with other remote devices 120, the interviewer system 130 has its own local storage and has device operational logic, in this case interviewer operational logic. In this implementation the interviewer operational logic is stored in the local storage, and comprises computer-readable instructions instructing a processing entity in the interviewer system 130 to perform the functions described herein. In this particular case, the program instructions are loaded from the server 110 as described herein.

Among the static items loaded from the server 110, besides JavaScript, are pages (e.g. provided using html code) which together with the functionality conferred by the script, present to the interviewer user a graphical user interface. These are loaded following a login procedure as described above. Based on the credentials 825, the server 110 knows that the particular user profile behind the request is a interviewer profile and therefore provides the appropriate static items including the appropriate device operational logic, if necessary.

The server operational logic 165 comprises function to generate a directive to do an interview and to transmit that directive to an interviewer system 130 associated with an interviewer profile. In particular, the server operational logic 165 can generate a directive associated with the interviewer profile. The directive may be a message or more generally a transmission (in this example an http packet based transmission) and may be a response to a request from the interviewer profile for interviews to perform (a job request). The directive may be generated and/or transmitted on the basis of an interview request. The directive may also be generated and/or transmitted on the basis of request from an interviewer profile for interviews to do. The directive may also be generated and/or transmitted on the basis of a determination that an interview to be done is associated with an interviewer profile and the transmission may be to that particular interviewer profile or more particularly to an interviewer station associated with that profile. In the present example the directive is generated on the basis of an interview request (more specifically here on the basis of the presence in the database 115 of an indication that the interview is to be conducted which is present in the database 115 as a result of the interview request) and on the basis of a request from an interviewer profile for interviews (or more particularly associated with the interviewer profile) to be conducted, and further on the basis of a determination that the interview is associated with the interviewer (in this example, this is verified by a function called as a result of receiving the request from the interviewer profile) and is transmitted to the interviewer profile (and more particularly in this case to a remote device (here an interviewer system, which is a computer in this example) associated with the interviewer profile).

Thus an interviewer logs onto the system 100 in much the same way as the manager did but the log in credentials/token it provides identifies the associated profile as an interviewer profile to the server architecture 105. (In an alternate embodiment, separate interviewer login page could be provided at a different URL.) As a result, static elements defining the graphical user interface (including in this example html and JavaScript) that are loaded onto the interviewer system 130 provide an interface that is customized to the interviewer tier.

The interviewer system 130 provides a system for conducting interviews. Like with the management system, the graphical user interface may have multiple panes for presenting different types of information. In one example, after logging in with interviewer profile credentials, the user is taken to an “interviews” pane showing a list of the interviews to be conducted, including interview data from entries in the interview table 420 (e.g. date and deadline data) as well as data from other associated entries in other table forming together an interview profile, which may include the name and contact information of the respondent from the respondent table 390 (identified in a field the interview table 420). These information may all be listed in rows in the interviews pane. The listed information may also include an interview deadline. In this manner the system 130 may provide functionality similar to CATI (Computer Assisted Telephone Interviewer) systems but provides additional functionality. Together with the server architecture 105, it may be called a CATIMP (Computer Assisted Telephone Interviewer and Mobile Publishing) as interview results may be published to mobile in real time.

The interview data may be loaded upon login or as a result of clicking on an “interviews” tab or button like with the management graphical user interface. Doing so causes the interviewer operational logic to generate a job request to the server architecture 105, and more particularly here to the server 110 to return the required information. The server 110 performs a three-tiered verification of token validity, tier, and permissions and seeks the required data from the database 115. To this end, the server operational logic 165 may comprise a interviews.findAllToDo function which searches with the interviewer profile's tier and specific permission for the interview data in the interview table 420 retrieves interview data which includes data associated with interview table 420 entries in other tables such as respondent data and returns it as a response to the request.

In this example, the interviews.findAllToDo function comprises a verification of the indication that an interview is to be conducted for at least a portion of the possible interviews. In this particular example the function causes a search of all the interview entries in the interview table that are associated with the associated with the interviewer profile (e.g. by being associated with a campaign associated with the interviewer or by virtue of any other direct or indirect associations) originating the request. When an interview entry is found, in this particular example, the function causes a verification of the status indicator for found interview entries. The returned in the request are associated with an indication in memory that they are to be conducted (in this case, they all at least correspond to an existing interview table 420 entry that has a status set to “to do”) and thus the transmission of the corresponding interview data for an interview is based at least in part on the presence of the indication that the interview is to be conducted.

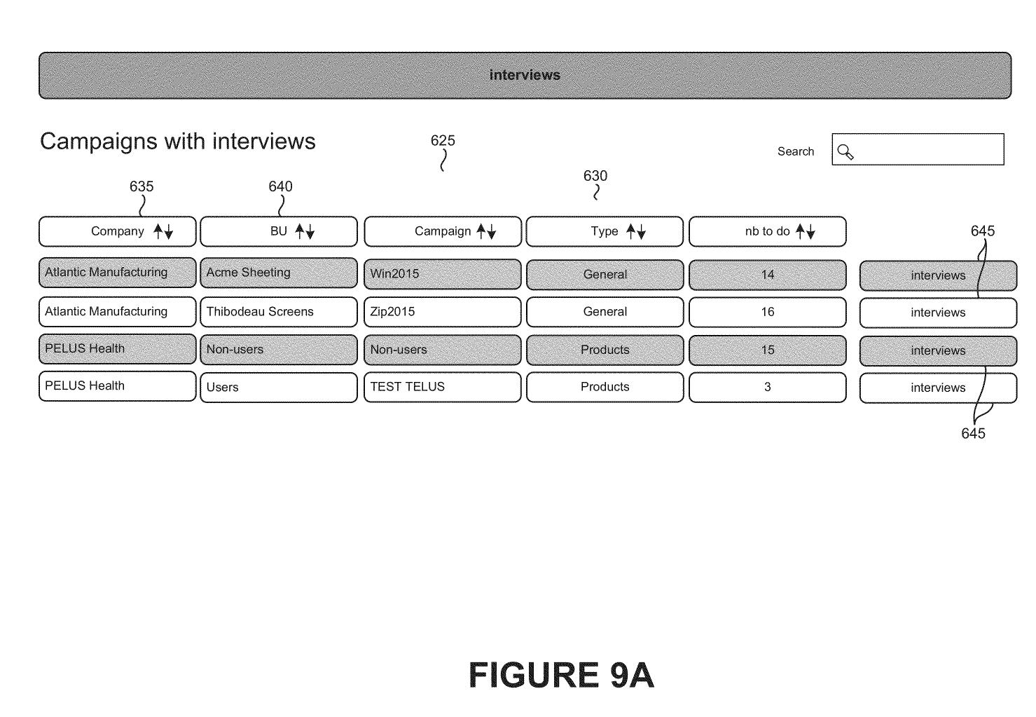

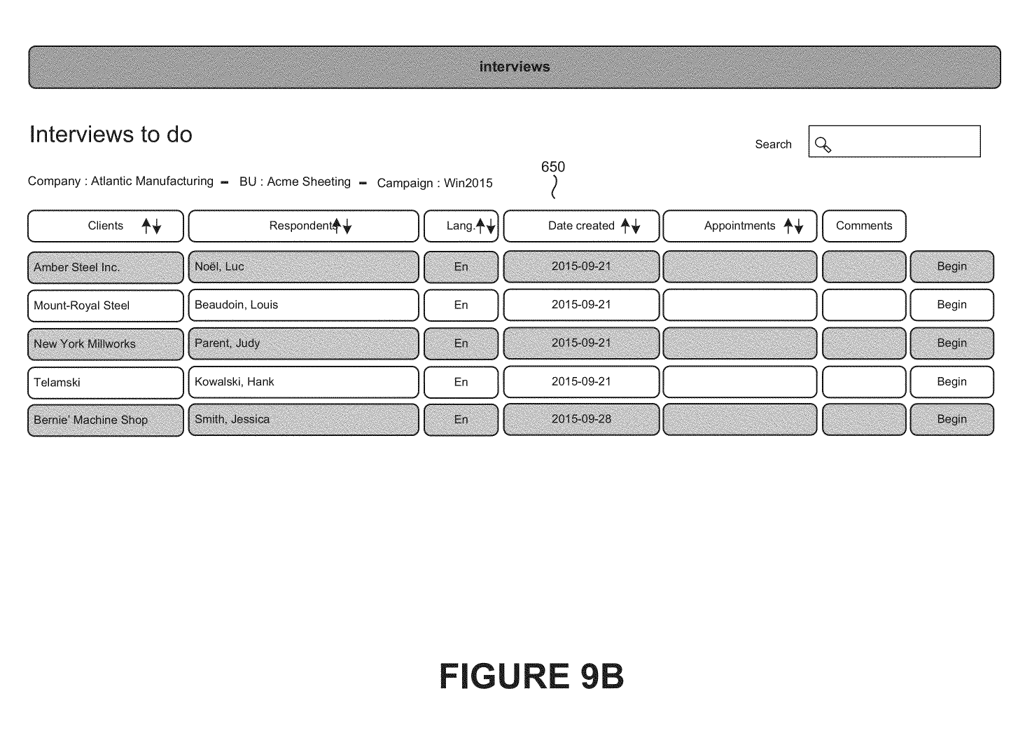

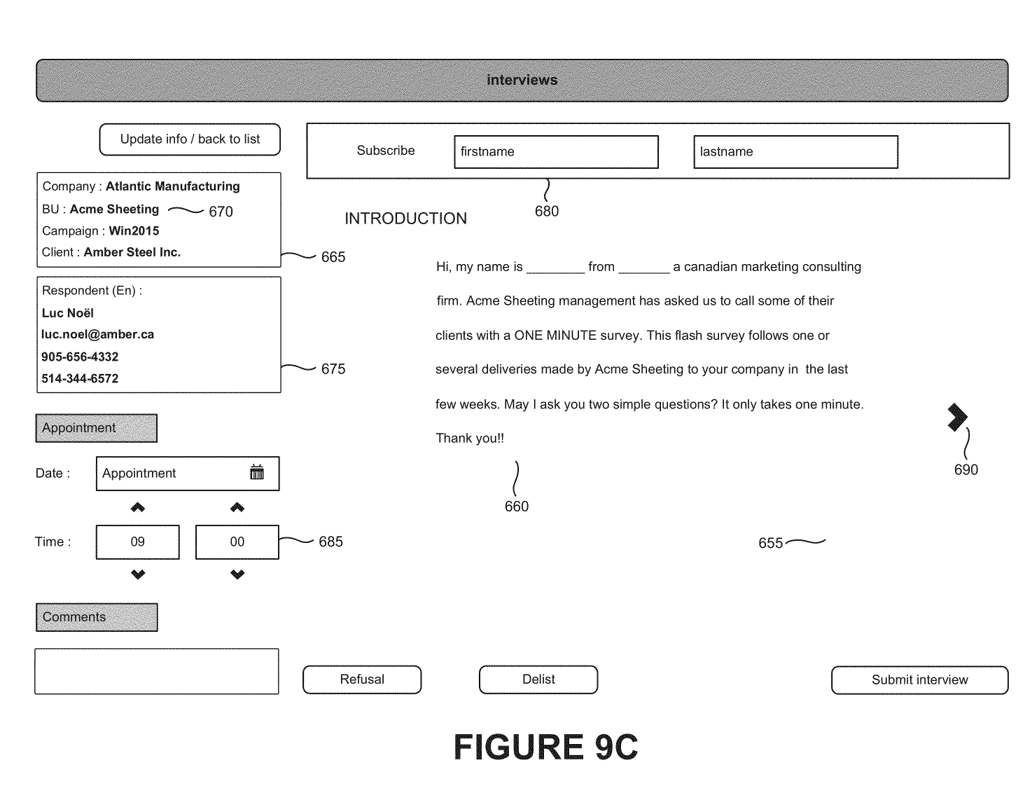

FIG. 9a shows a screen capture of an exemplary welcome screen 625. In this particular embodiment, once logging in is complete, this welcome screen 625 which presents a breakdown table 630 comprising a list of the different campaigns which comprise interviews to do. The list is broken down into businesses in a business column 635 and business units within the businesses in a business unit column 640. The list also comprises a column for the name of the campaign, a column for the type of the campaign (in this example they are broken down into “general”, “products”, or “services”), and the number of interviews to do. All this information is obtained from the database 115 via a suitable request generated by the interviewer operational logic, e.g. in response to the login being completed. In response to the request the server operational logic 165 applies functions, after the three part validation, that access the database 115 to derive the listed information and provides it in a response to the interviewer system 130.

The user of the interviewer system 130 can then select a campaign by clicking on the interview button 645 in the row of the campaign to select. This causes the display of an interviews table 650 listing the interviews to do in a job pane, as shown in FIG. 9b. This may be have obtained earlier with the rest of the interview/campaign data, but in this embodiment clicking on an interview button 645 causes the manager operational logic to generate and transmit a request for details of individual interviews pertaining to the campaign, business and business unit of the row. This in turn causes the server operational logic 165 to call a function, after the three-part validation, that obtains the information from the database 115 and transmits it back as a response. The information displayed on the interviews table 650 is a list of interviews to be conducted, with information including the name of the client, name of the respondent, language of the interview, date it was created, appointments (if any), and comments (optional) from the interviewer to himself/herself. The interviewer operational logic may sort them in order of urgency. A “do interview” button next to each entry in the list causes the interviewer operational logic to generate another request for more interview data from the server architecture 105, and more particularly the server 110. This request seeks to obtain the interview questions for the campaign to which the interview belongs. The request includes as parameters the token, as usual, as well as a campaign ID, as found in the interview data (it is a field in the interviews table 420). A questions.findAll function is provided in the server operational logic 165 which accepts as arguments the token and the campaign ID. A response is returned to the interview system 130 comprising all the interview questions for the campaign. In this particular example, all the questions are pre-loaded into the interview system 130, and the interviewer operational logic provides the sequential display of the questions for the interview. However in other implementations, the questions may be presented and requested one-at-a-time as the interview is being conducted.

Clicking on the “do interview” button may also cause the generation and transmission by the interview operational logic of a request to change the status of an interview from “to do” to “being done” (or “underway”). Again, this request may be validated by the three-step approach and a confirmation response may be generated by the server operational logic 165 and returned.

Clicking on the “begin” button may also cause the generation and transmission by the interview operational logic of a request to obtain other interview or more broadly campaign data, such as the introduction to read, that is stored in the campaign table 400. Again, this request may be validated by the three-step approach and a response comprising the campaign data may be generated by the server operational logic 165 and returned.

The interviewer at the interviewer station 130 thus has a system whereby he can see the interviews to be done, including respondent contact information, and can contact the respondent by telephone. Optionally, this system may be linked to an auto-dialer of the type found in telemarketing rooms.

Having called a respondent and clicked on “do interview” for a particular interview, the interviewer is presented by the interviewer operational logic the introduction text, and asks the respondent for his/her consent to conduct an interview. The graphical user interface on the interviewer system 130 shows the introduction text and presents an input tool to signify consent, in the form of a “next” button. In one advantageous embodiment, the interview is extremely short, consisting of only two or three questions and thus the interviewer can assure the respondent that only 2 minutes will be required.

Having received consent, the interviewer can then clicks on next and the interviewer operational logic displays in a pane the first questions and a tool for inputting an answer to the first question. If the answer is an open-ended question, the tool may be in the form of a text box. If the answer is in the form of a multiple choice question, the tool may be an answer selector with response choices display (e.g. radio buttons or checkmarks, depending on whether only one or plural answers are accepted). Another “next” button or the like may also be displayed (it may be grayed out and unclickable until an answer is inputted) for moving on to the next question. Inputting an answer and clicking on next could in some embodiments cause a request to generate and/or update a response entry in the response table 425 but in the present example, the results are accumulated locally and transmitted only once the interview is completed and the final “next” button has been clicked.

Once this is done, the interviewer operational logic generates and transmits a request to the server architecture 105 and more particularly to the server 110 which provides the results gathered. This request is a result-providing request and comprises result data. The result data is indicative of the results of the interview with the client; in this implementation it is indicative of the results of the interview, which in this case is response data representative of answers provided by the client (and more specifically here by the respondent) during the telephone interview, which was conducted here by an interviewer associated with the interviewer profile. The result-providing transmission of this example is a single transmission which comprises a URL identifying the server and a function or action of the server, which bears the token in the header and which comprises the result data. However, in other embodiments the result-providing transmission could be a collection of a plurality of packets or transmissions. The server receiving this requests is caused (by the router module 160) to call up a interviews.complete function in the server operational logic 165 which, upon triple validation again, causes the creation of a response entry for each question and associate these entries with the particular interview entry of this interview. The function also causes an update of the interview entry to change the status to a value indicating “completed”, and causes an update of the interview_stats table 430.

FIG. 9c shows an interview window 655 of the CATIMP. The system provides the interviewer associated with the interviewer profile with campaign data such as an introductory text to read 660. The system also provides the interviewer associated with the interviewer profile with client data such as client information 665 showing the name of the client. The system also provides the interviewer associated with the interviewer profile with business unit data, in this case business unit information 670 showing the name of the business unit. The system also provides the interviewer associated with the interviewer profile with respondent data, in this case respondent information 675 including the name and contact info of the respondent. The system also provides the interviewer associated with the interviewer profile with interview data, including interview information 685 showing an appointment time, if any.

The system also provides the interviewer associated with the interviewer profile with the ability to input data of the various types. The interviewer operational logic takes the input data and generates a request to provide it to the database. Upon receipt at the server 110, the server operational logic 165 executes the three part validation of the request and executes functions to access the database 115 and modify it by creating entries for the input data or modifying existing entries to provide the input data. This includes in this example the ability to input a substitute respondent, e.g., if the respondent is unavailable, to input an appointment time, e.g. if the respondent wishes to set one (e.g. “I can't talk now, could you call me at 6?”), and of course the ability to provide response data. Navigational tools such as “next” arrow 690 allow the user to navigate through the interview data, and more particularly in this case through the question data to provide response data.

Optionally, this function may also trigger an alert if the results of the interview are poor (e.g. below a certain threshold and/or a certain negative difference from a previous interview result for the same client). This alert may be in the form of an e-mail sent to the representative in charge of the client and/or to the manager and/or to a VP.

Advantageously, the web-to-web interface of the system 100 allows access to the system 100 from a large variety of locations. In an exemplary implementation, representative user have access to their interview results in real-time via a mobile interface.

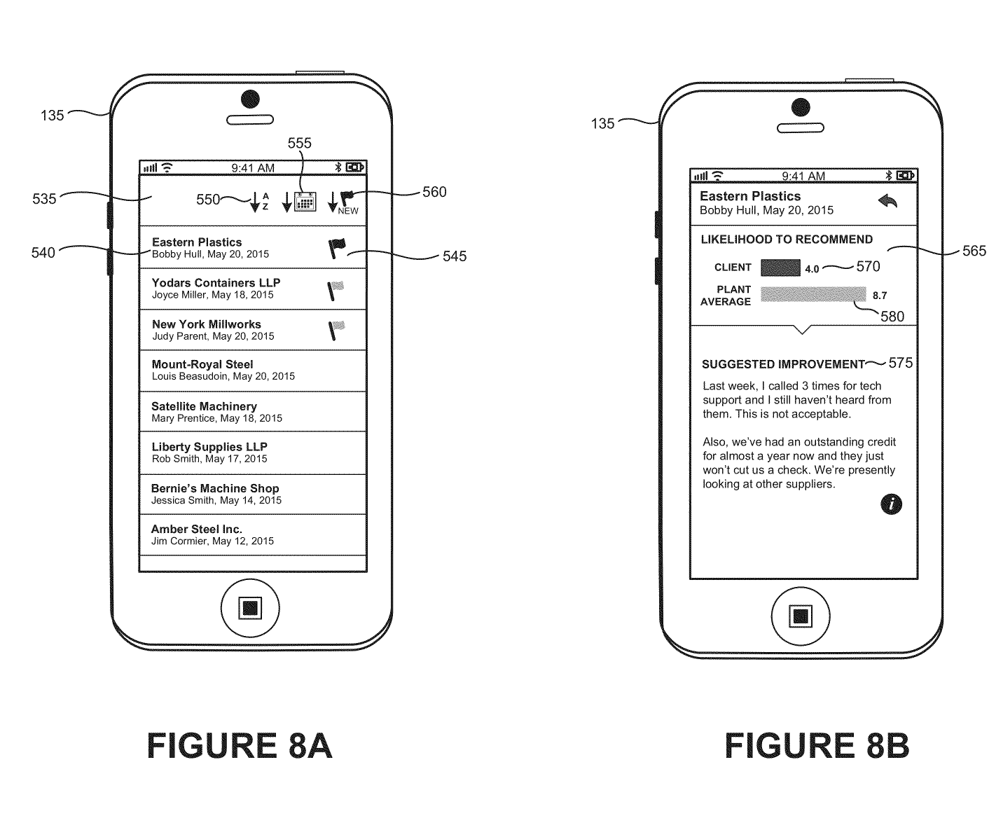

The mobile interface may take the form of a webapp, which may be saved (as a link) on a mobile device desktop. The webapp provides a link to the login page, which when accessed by a mobile device is a mobile login page (although a separate URL for mobile devices could also be used). The user logs in much the same way as described above for other user tiers. Based on the user's credentials upon login, the server architecture 105, and more precisely in this case the server 110 identifies the user as a representative user profile and provides a simple mobile-based interface as shown in FIG. 8.

Like with other remote devices 120, the representative's mobile device 135 has its own local storage and has device operational logic, in this case representative operational logic. In this implementation the representative operational logic is stored in the local storage, and comprises computer-readable instructions instructing a processing entity in the mobile device 135 to perform the functions described herein. In this particular case, the program instructions are loaded from the server 110 as described herein.

Among the static items loaded from the server 110, besides JavaScript, are web app data including pages (e.g. provided using html code) which together with the functionality conferred by the script, present to the manager user a graphical user interface.

In the present embodiment, the server operational logic 165 provides the representative profile (and more precisely in this example, transmits to the mobile device 135) result data at least partially on the basis of the presence of the result data in the database 115, and more particularly on the basis of the presence of interview results pertaining to an interview or client which is associated with the representative profile. In this particular example, the server operational logic 165 provides this result data on the basis of a request from the representative profile and on the basis of the presence of the results. Doing so in this example comprises a search to determine whether the results are present in the database 115, however in alternate embodiment, a flag may be stored by the server operational logic 165, e.g. in association with the user profile, upon receipt of the result data.

FIG. 8 illustrates a mobile device 135 accessing the system 100. A welcome pane 535 is displayed in FIG. 8, showing a list of all the representative's clients. To this end upon logging in, the interviewer operational logic causes a request to be generated and transmitted to the server architecture 105 and more precisely in this example to the server 110 requesting the list of all clients and interview statuses. The request being received at the server 110 is processed by the router module 160 who calls a server operational logic 165 function: clients.findAll, which uses the token data with three-part verification to find all the clients that are associated with the representative profile. The function moreover causes the server 110 to access the database 115 to go through the interview table 420 and identify any interviews associated with clients that are associated with the representative profile behind the request. For those interviews that match, the function derives some interview data including the interview status flag and optionally the date of the last interview. The function also derives some result data, in this case an overall score, either from the response table 425 or from the interview table 420, if such data is kept there. Finally, the function also consults the interview_stat table 430 to find all interviews for this representative profile that have not yet been consulted. This interview data is returned alongside some client data including a client name and address in a response message transmitted back to the mobile device 135.

The mobile device 135 receives this response and the representative operational logic presents it in the welcome pane 535. Alternatively the data can be formatted visually by the server and sent as a mere web page to the mobile device that does nothing but display it as received. In this example, however, the representative operational logic prepares a scrollable list of all the clients, shown in visual representations 540 which in this case are list rows which feature the client's name address and date of last interview. For interviews that have not yet been consulted, the representative operational data causes a visual indicator 545 of a new interview to be displayed in association with the client data. In this particular example, the visual indicator 545 is a flag icon in a color representative of the interview results. Red symbolizes a poor result, yellow a medium/neutral result and green a positive result.

The welcome pane also features a sort alphabetically icon 550, a sort by last interview icon 555 and a sort by un-consulted-results-first icon 560. Clicking on these have the obvious result which in this case is computed locally by representative operational logic received from the server 110.

The mobile user can scroll through the list and select a result to view by clicking on it on the touch screen. In response to this the representative operational logic will generate and transmit a request to the server architecture 105 and more precisely in this case to the server 110 identifying the particular client and requesting interview results. In response the server 110 may call the interview.readResults function. This function is provided with the token and an interview ID (which was received with the interview data at the previous step) and performs a token verification for validity, tier and permission and retrieves result data from the response table 425 (and optionally question data from the question table 405 and response choice data from the response_choice table 410 to display alongside the responses). The server operational logic 165 generates a report transmission for the representative profile comprising at least a portion of the result data (in original form as stored or altered for the remote device) which it transmits as a response to the representative profile at the mobile device 135 for display to the user. In addition, this function may also note that a representative in charge of a particular client is accessing the results of a particular interview and update the interview_stat table 430 accordingly, e.g. by creating an entry indicative of the consultation.

FIG. 9 shows n example of results display. In this particular example, the interview comprised only two questions: 1) “On a grade of 1-10 how likely are you to recommend our business to someone else?” (a multiple choice question), and 2) “How can we improve?” (an open-ended question).

As shown in FIG. 9, a results pane 565. This pane shows the results of the last interview including a visual indicator in the form of a sliding scale 570 for a scaled multiple-choice question and a transcript 575 of the answer to the open-ended question. In this particular example, the operational data in the database 115 also includes a plant average, computed by an averaging function in the server operational logic 165 applied every time a new interview is conducted and stored an appropriate place in the database such as in the client table 395. This data only concerns the scaled multiple choice question and is also retrieved by the interview.readResults function and provided visually here in the form of a visual indicator shown as sliding scale 580.

The results pane 565 comprises a form of individualized user-specific report that is generated specifically for the user profile accessing it, in this example as a function of the user profile's associations and/or permissions. The report may also be generated as a function of the user profile's tier. In this example, the report is a representative report for a representative tier, that is provided to the representative profile because the client that is represented in the report is a client that is associated with the user profile. Advantageously, in this example the report is published to mobile and is formatted for viewing on a mobile device.

The welcome pane 535 provides a listing of available report and a graphical user interface framework that allows browsing through user-specific reports to access the contents of user-specific reports. Specifically it displays a list of user-specific reports for selection by a user using a graphical user interface tool to open a user-specific report and display the contents thereof to the user, optionally after requesting the contents on the basis of the selection.

Although in this embodiment the representatives access the system 100 using a mobile device 135, in alternate embodiments, representative profiles may access the system using a fullsize computer-based interface like the manager profile does.

The VP function is similar to the managers, only the VP has access to a larger range of data since a VP may be associated with a number of business units. The VP, however, may not necessarily have access to all the functions the manager does, for example in some embodiments he may not be able to select clients to interview. The BU admin for its part is provided with a similar interface, but has observational access to the data (client list, interview results) pertaining to the particular business unit it is associated with.

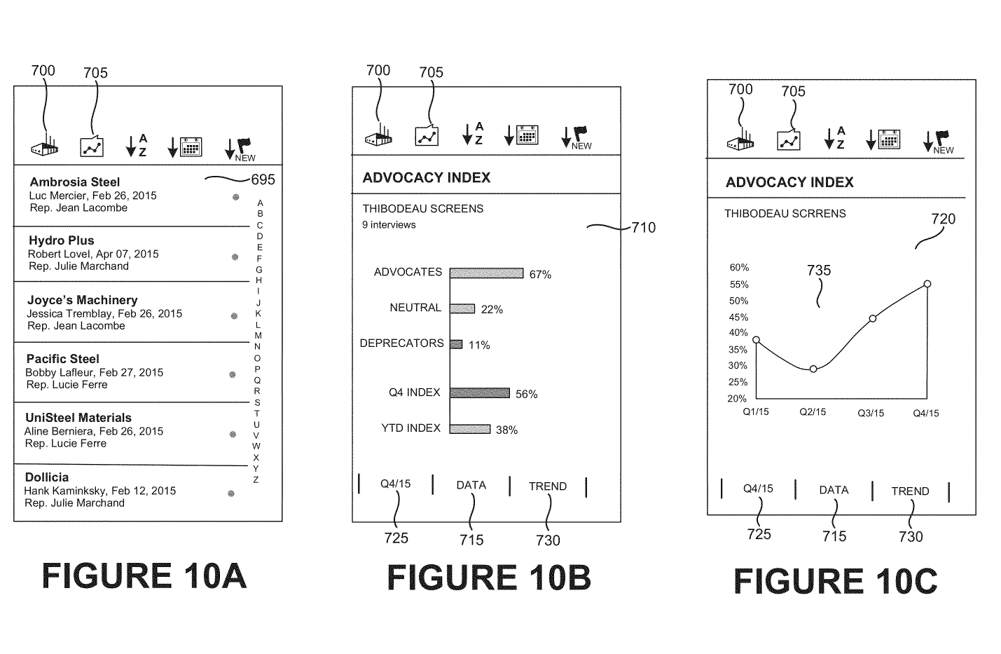

FIG. 10a shows a graphical user interface for a VP mobile device. This graphical user interface is similar to the representative user interface in that it lists in a VP welcome pane 695 a list of interviews that have been completed. However, in this example, the list comprises all the interviews for a particular business unit and shows the representative associated with the client for each interview. A bu_select button 700 pulls up a business unit pane showing the different business units associated with the VP profile of the user of the VP mobile device, and allows the user to select a different business unit.

In this example, statistics are also provided, which are computed from the result data in this example using the VP mobile device's operational logic from result data but which could in alternate embodiments be computed using the server operational logic 165 and transmitted to the VP mobile device and/or stored in the database 115 for later use. A statistics button 705 allows causes the display of statistics information. Various statistical information may be presented, but in this example statistics pertain to a particular client, and more precisely in this example of the client of the current or most recently selected interview.

FIG. 10b shows a first statistic pane 710 showing quarterly results for a particular client. Below the first statistic pane 710 is a set of buttons 715 of which a quarter button 725 is selected indicating that quarterly results are desired. The pane lists the name of the client and the number of interviews conducted, and classifies the respondents as either “advocates” (e.g. if they provided a score above a certain threshold), “deprecators” (e.g. if they provided a score below a certain threshold), and “neutral” (e.g. if they provided a score between the two thresholds). The first statistic pane 710 shows a graphical illustration of surrey results at for a particular time period (in this case for a quarter). Here the graphical illustration includes an relative illustration (in this case a bar graph) of respondent or interview classifications (here: advocates, neutral and deprecators), and a aggregate score shown on a sliding scare for the quarter and for the year to date.

FIG. 10c shows a second statistic pane 720 showing a visual representation of performance progress over time which in this example is a graph 735. The performance progress over time may be within certain parameters (e.g. profile parameters), such as for a particular representative profile, business unit profile, client profile, of for the business as a whole. In this example, the performance progress is for a particular client profile as measured an aggregate score for particular periods (here quarters) over a range of time (here four quarters).

The business unit administrator may likewise be linked to particular representatives in order to have access to survey results in like manner than the representatives do but for a plurality of representatives under his watch. This may be done by providing the BU_admin table 350 entries with a (1:N) relationship to entries in the representative table 340, and to provide in the server operational memory 165 functions similar to those for the representative profile (including perhaps using some of the functions used for representative profiles) but taking into account the business unit administrator's access to result data from clients of multiple representatives. If representatives may likewise have multiple business administrators (rep profiles associated with multiple BU admin profiles) this may be accounted for by using a relationship table similar to the respresentative_mgr table 360.

In the above examples, the device operational logic on the remote devices 120 was provided by way of script downloaded from the server architecture 105 and more particularly from the server 110. This is useful as it requires no installation and the remote devices 120's operational logic 150 can be modified as desired to modify the system 100. However, in alternate embodiments, the operational logic 150 may be provided to the remote devices 120 in the form of a standalone program to be installed on each remote device 120. Such a program can be provided over the internet but is not necessarily downloaded from server 110.

It should also be noted that while in the main exemplary implementation, the system 100 was based on access by user profiles, in alternate embodiments, for example in the case where operational logic is provided using installed programs, the server architecture 105 may provide what has been provided above as request responses as push data to the remote devices 120. In such a case, the server operational logic 165 may comprise triggers for pushing data which may be based on received requests, on accesses to the memory or on a regular schedule. For example, interview data about an interview may be pushed to the interviewers in response to receiving a request from a manager indicating that the interview is to be conducted. Alternatively, the interview data push may be triggered by the access to the database creating the indication that the interview is to be created, e.g. by a monitoring function. Alternatively still, the push may be triggered by a regularly-scheduled function in the operational logic 165 that accesses the database 115 and searches (e.g. once a day) for the indication that an interview is to be conducted and triggers the push upon finding it. Likewise interview result data may be pushed to the mobile device 135 in a similar manner on the basis, for example, of the completion of an interview. Here too the push may be triggered, e.g., by the receipt of the result data from the interviewer profile, by the access to the database 115 to store result data therein, or by a scheduled function. When a transmission is triggered by the receipt of data that is to be stored in the database 115, the transmission may be generated with the data as received without first storing it into the database 115, and the data may be provided to the database 115 subsequently or simultaneously.

In another alternate embodiment, the function of the remote device 150's operational logic 150 may be kept at server architecture 105, e.g. at the server 110, with the server providing the remote device nothing but visual information such as a custom-made web page with all the computations and operations performed on and with the data from the data base 115 being performed at the server 110, and with only the result being sent to the remote device 120,

In an extension of the system 100, the system itself may be licensable as a unit to a survey or business intelligence company. To that end, a license administrator user tier is provided and the database 115 data comprises a license_admin table 355 comprising an entry for every license administrator if there is more than one.

The license administrator profile has authority to license the system 100 to other companies for them to use to offer services under the system to businesses that are customers of their own, who will in turn use the system to monitor and improve their performance.

A license table 385 is an overarching structure comprising a license entry to which all the businesses using the system, as it has been described thus far, are associated. So far the above examples and embodiments have been described assuming a single license exists (only one company offering the system 100). All the data types, other than the license_admin table 355 entries and license table 385 entries belong to (or are associate with) directly or indirectly the single license entry in the license table 385. A second license entry may be created essentially replicating the entire system, as it has been described so far, for another system provider. A whole new set of all the types of data may now exist in association with the second license.

This provides a multifaceted system where multiple system providers may coexist on a same platform. While the multi-faceted aspect of the system 100 may provide a source of revenue for an original provider to license the system to competitors, it may also be used even when full duplication of services is not intended as a long-term consequence. For example the creation of a new license may be a useful way to provide a potential acquirer with a smooth transition mechanism towards integrating the system 100 without necessarily having to mix the acquirer's customer base with the original system operator's customer base.

The license administrator profile may be accessible through a same web-based interface as has been described above with respect, for example to the manager profile. In this case, however, the license administrator may have access, for example, to all functions and data in the system 100. In practice, however, the license administrators are principally concerned the administration of licenses and have an interface permitting the creation of new licenses by sending requests to the server architecture 105 and more particularly the server 110 to create new licenses which cause the server operational logic 165 to call a function to that effect, e.g. a license.new function which takes the license administrator's token for the three part verification and license parameters, as provided by the request, to create a new license entry in the license table 385. In the present example, a license administrator is associated with a license administrator profile and uses administrator station 140.

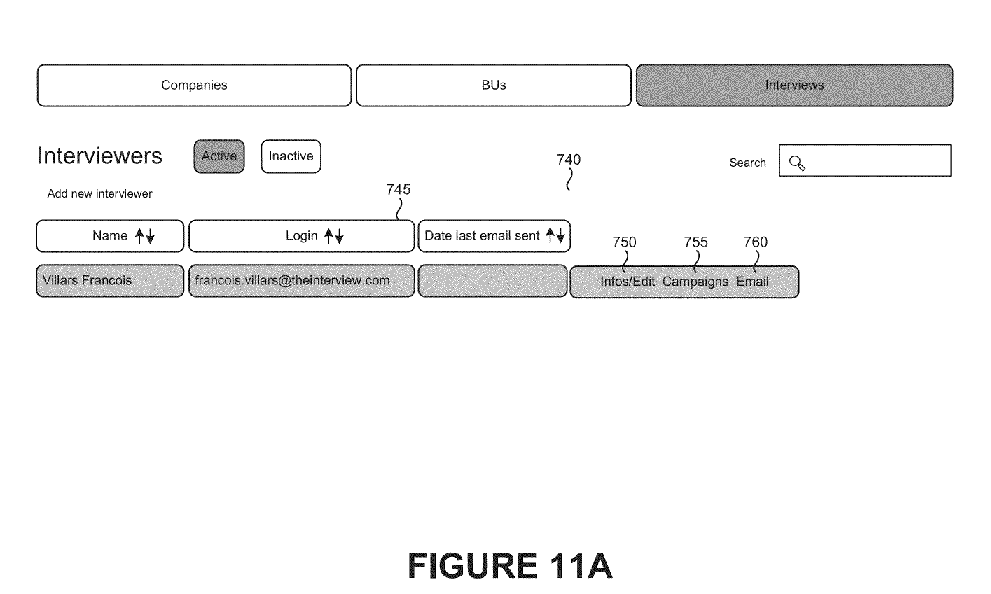

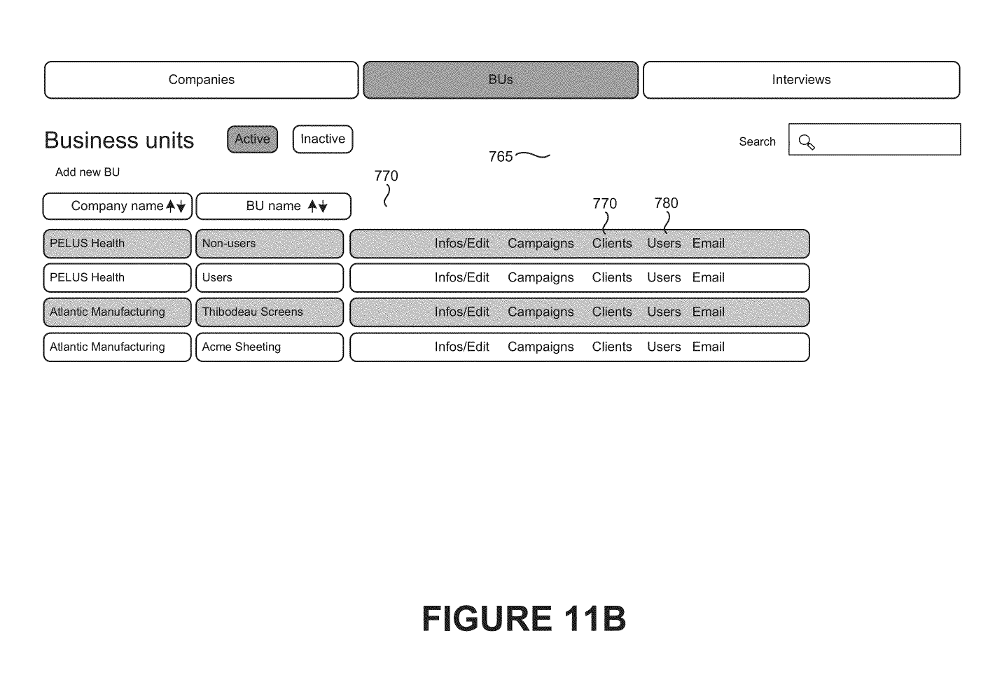

In an example of license administrator interface, FIG. 11a shows an interviewer pane 740 showing a list of interviewers. Using this interface, which is accessed via login procedure as described above, the license administrator can have access to the list of interviewers for the system 100 (or, in alternate examples, to the list of interviewers for a campaign, for a business, or for a business unit) which is requested by the remote operational logic at the administrator station 140 (which is in fact in this example simply a computer using a browser like the manager computer 125 and the interviewer system 130) according to the request procedure described herein and which is accordingly accessed in the database by the server operational logic following a three part validation of the request and provided in response as described herein. In an interviewer table 745 a list of interviewer profiles is shown along with buttons to edit the interviewer profile data 750 (similarly to the clients list described earlier), to obtain and view/edit the campaigns associated with the interviewer profile 750, and to e-mail the interviewer 760, the latter calling an external e-mail function or program. New interviewers can also be added using this interface, in this example by editing an empty row of the interviewer table 745.

FIG. 11b shows a business unit pane 765 with a bu table listing the various business units, shown as entries in the table with the name of the associated company in one column and the business unit name in the next column. Similar buttons as provided in the interviewers table 745 are provided here, with the addition of a clients button 770 and a users button 780, which like the campaign button 750 allows viewing/editing/addition of clients and users by the user of the administrator station. A similar pane and functionality is also provided for companies, which includes a company table with similar options.

With the foregoing description, also provided here is a content management system which may be configured to allow access to the providers (e.g. a license administrator associated with a license administrator profile or more generally a provider of the system 100) to log into their account and upload the contact information of new clients to be interviewed. A provider may be able to indicate the questions that need to be asked to the client. This allows for personalizing the questions depending on the type of business/service that each provider provides to its clients.

The CMS may be configured so that the upload of each new contact may trigger a clock to ensure that the client gets contacted by the survey centre within a short period following an event. The CMS may also allow the provider to create requests associated with existing clients that were previously entered into the CMS for a periodic check of the client's satisfaction of an ongoing service or following a new event associated with the same client.

The CMS may also provide access to survey centre. The survey centre may be associated with the CMS and may also be separate/independent. As indicated above, the survey centre accesses the CMS to obtain the contact information of the clients that need to be contacted. The CMS may be configured to alert the survey centre every time a new entry is received by a provider. A personnel from the survey centre may contact the client and enter the information collected from the client into the CMS directly. The results may be provided instantaneously to selected personnel at the provider e.g. executives, managers, representatives, etc. using a web service or the like in the click of a button. For example, results (or critical results) may be sent to mobile devices of selected personnel along with a push notification for immediate attention.

In another exemplary system for measuring client satisfaction in b2b enterprises, the system comprises an event detection module. The module may be configured to detect the sale, delivery, or otherwise to a client. The module may take the form of a software module, a hardware module or a combination thereof. The event detection module may also be located at the provider or at the survey centre or may be divided between both. In an embodiment, the module may be part of a web-hosted content management system CMS, whereby the provider periodically lists or uploads the contact information of customers that need to be contacted, which info may be accessed or made available to the survey centre to conduct the survey.

Upon detection of the event e.g. a new customer being added by the provider in the CMS, the event module may trigger a request for a survey and send the latter to a survey centre. The survey centre may be provided remotely at a firm that specializes in conducting surveys. In an embodiment, the request may be accompanied by a deadline e.g. 0-48 hours to perform the survey. In an embodiment, the survey may be telephonic/audio and may also be in the form video conference mode e.g. Facetime®. In any case, the embodiments require the survey to be initiated by a service agent to involve a person to person conversation and to be very. The survey may be short and may include a mix of open ended questions and closed-ended questions such as Yes/No questions, multiple choice questions and questions where the user expresses their satisfaction using a scale e.g. 1 to 10. In a non-limiting example, the survey may be short and preferably includes only two questions: 1) a “close-ended” YES/No, or Scale from 1 to 10 question and 2) an “open question” that would let the client express their experience in their own words. For example the YES/NO question may be: “Would you recommend this company?”, and the open question may be “what improvements can the company make?”.

The survey centre may contact a client to conduct the survey. The answers received may be entered into the CMS system to be made available to the provider instantaneously. Information entered/stored in the CMS may be distributed via a traditional web server or on the “Cloud”, to the providers on their mobile devices (smartphones, tablets or the like) or other types of computing devices. For example, using an app installed on a portable computing device or using a web-page, the provider may access the results immediately as soon as the results are made available by the survey centre. The delivery of the results may be tailored to the needs of the provider e.g. raw data is presented to given personnel, average results to others etc. depending on the preferences and ranks of personnel at the service provider.

In a further embodiment, the results may be color coded to flag those which require immediate attention. In an example of the survey results for a given provider, the results are shown on a portable computing device e.g. smartphone, tabelt and the like. The results show an unhappy customer with a red flag, a customer with average satisfaction with a yellow flag, and a happy customer with a green flag. The results may be reordered based on recency, date, alphabetical order etc. For example, the results have been reordered. The results associated with each client and the collective average for all clients may be provided. For example, the name of client, the score given by that client, the average score from all clients, and the message provided by the client may be shown.

For a more global view of their client data, users can access all responses for all clients in their dedicated CMS account over the web.

While preferred embodiments have been described above and illustrated in the accompanying drawings, it will be evident to those skilled in the art that modifications may be made without departing from this disclosure. Such modifications are considered as possible variants comprised in the scope of the disclosure.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A centralized real-time performance monitoring system comprising a server architecture accessible for communication over a data network, the server architecture comprising:
a. a computer-readable memory comprising:
i. at least one client data set comprising a plurality of client profiles and comprising for each of the plurality of client profiles client profile data;
ii. a user data set comprising tiered user profiles each of which belonging to at least one tier from amongst a set of tiers comprising at least an interviewer tier, and a representative tier, wherein each tier is associated with a different level of access to data in the computer-readable memory;
b. a network interface configured to receive requests from remote devices, the request being associated with a user profile and to transmit responses to requests to the remote device from which the corresponding request originated;
c. the operational logic in operative communication with the network interface comprising computer-readable instructions instructing a processing entity to:
i. generate and transmit to an interviewer remote device associated with an interviewer user profile of the interviewer tier a directive indicative that an interview is to be performed on a particular client;
ii. accept a result-providing transmission associated with the interviewer user profile from the interviewer remote device comprising result data indicative of interview response from the particular client, and in response to the results-providing transmission, access the computer-readable memory to store the result data in association with the particular client profile;
iii. determine an association between the particular client and a representative user profile associated with the representative tier; and
iv. at least partially on the basis of the presence of the result data and of the association between the representative user profile and the particular client, generate a report transmission comprising at least a portion of the result data, and cause the transmission of the report transmission to a representative remote device associated with the representative user profile.

2. The centralized real-time performance monitoring system of claim 1, wherein the set of tiers further comprises a manager tier, and wherein each tier is further associated with a different level of access to operational functions of the operational logic, and
wherein the operational logic further comprises computer-readable instructions instructing the processing entity to: accept an interview request associated with a manager user profile from a manager remote device comprising an indication that the interview is to be conducted, and
wherein the operational logic further comprises computer-readable instructions instructing the processing entity to transmit the directive to the interviewer remote device at least in part in response to the interview request.

3. The centralized real-time performance monitoring system of claim 2, wherein each of the representative user profile is associated with at least one respective manager user profile and wherein each client profile is associated with a representative user profile; and
wherein the operation logic comprises computer-readable instructions instructing the processing entity to identify the tier of the user associated with all incoming requests and to accept interview requests only from users associated with the manager tier and to accept result-providing transmissions only from users associated with the interviewer tier.

4. The centralized real-time performance monitoring system of claim 2, wherein the operation logic comprises computer-readable instructions instructing the processing entity to transmit to the manager remote device a client list comprising a plurality of clients associated with the manager profile, and
wherein the interview request is representative of a selection by a manager user associated with the manager user profile of the particular client from the client list.

5. The centralized real-time performance monitoring system of claim 2, wherein the operational logic further comprises computer-readable instructions instructing the processing entity to in response to the interview request, access the computer-readable memory to generate in the computer-readable memory an indication that an interview is to be conducted for a particular client profile, and wherein
the operational logic further comprises computer-readable instructions instructing the processing entity to generate the directive at least in part in response to the presence of the indication that an interview is to be conducted.

6. The centralized real-time performance monitoring system of claim 5, wherein the operational logic further comprises computer-readable instructions instructing the processing entity to accept a job request associated with the interviewer user profile from the interviewer remote device, and
to validate the job request to determine that the interviewer user profile is associated with the interview or the particular client, and
to generate the directive at least in part in response the job request and the validation of the job request.

7. The centralized real-time performance monitoring system of claim 1, wherein the operational logic further comprises computer-readable instructions instructing the processing entity to accept a result request associated with the representative user profile, and
to access the computer-readable memory to determine that it comprises the result data and to validate the result request to determine that the representative user profile is associated with the result data, and
to cause the transmission of the report transmission to the remote device associated with the representative user profile at least in part on the basis of to the result request and the validation of the result request.

8. The centralized real-time performance monitoring system of claim 7, wherein the operation logic further comprises computer-readable instructions instructing the processing entity to at least in part in response to the result-providing transmission, access the computer-readable memory to create therein an indication that the response data has not been accessed with the representative user profile.

9. The centralized real-time performance monitoring system of claim 8, wherein the operation logic further comprises computer-readable instructions instructing the processing entity to at least in part on the basis of the job request, access the computer-readable memory to create therein an indication that the response data has been accessed with the representative user profile.

10. The centralized real-time performance monitoring system of claim 1, wherein the operational logic further comprises computer-readable instructions instructing the processing entity to access client data from the computer-readable memory and to transmit client data to the interviewer device along with the directive.

11. The centralized real-time performance monitoring system of claim 1, wherein the computer-readable memory further comprises at least one feedback campaign data set comprising question data, the question data indicative of at least one interview question to be asked orally to a client over the phone, and
wherein the operational logic further comprises computer-readable instructions instructing the processing entity to access feedback campaign data comprising at least a portion of the question data from the computer-readable memory and to transmit the feedback campaign data to the interviewer device along with the directive.

12. The centralized real-time performance monitoring system of claim 1, wherein the computer-readable memory further comprises remote device operation logic comprising computer-readable instructions instructing a remote device to generate a request to the server architecture to access computer-readable memory.

13. The centralized real-time performance monitoring system of claim 10, wherein
wherein the remote device operation logic comprises at least interviewer operational logic and representative operational logic; and
wherein the operational logic further comprises computer-readable instructions instructing the processing entity to wherein the operational logic further comprises computer-readable instructions instructing the processing entity to transmit the interviewer operational logic to the interviewer remote device and to transmit the representative operational logic to the representative remote device.

14. The centralized real-time performance monitoring system of claim 1, wherein the operation logic further comprises computer-readable instructions instructing the processing entity to, in response to the result-providing transmission, create in the operational memory an indicator that the interview has been completed.

15. The centralized real-time performance monitoring system of claim 1, wherein the operation logic further comprises computer-readable instructions instructing the processing entity to implement an automatic selection function whereby a given period of time after having received the result-providing transmission, a second directive indicative that a second interview is to be performed on the particular client is generated and transmitted to the interviewer remote device associated with the interviewer user profile.

16. The centralized real-time performance monitoring system of claim 1, wherein the at least one client data set, and the user data set are a first client data set and a first user data set respectively and are each associated with a first licensing profile, the first licensing profile being defined in the computer-readable memory, wherein the computer-readable memory comprises at least a second licensing profile having respective associated second client data set and second user data set.

17. A method for providing differentiated real-time access to an operational data set stored in a computer-readable memory having comprising at least one client data set comprising a plurality of client profiles and comprising for each of the plurality of client profiles client profile data;
the real-time differentiated access being provided to different user profiles belonging to at least one tier from amongst a set of tiers comprising at least an interviewer tier and a representative tier, wherein each tier is associated with a different level of access to the operational data in the computer-readable memory, the method providing different level of access to the operational functions and data; the method comprising:
a. generating a directive indicative that an interview is to be performed on a particular client;
b. transmitting the directive to an interviewer remote device associated with an interviewer user profile of the interviewer tier;
c. receiving a result-providing transmission associated with the interviewer user profile from the interviewer remote device comprising result data indicative of interview response from the particular client, and in response to the results-providing transmission, accessing the computer-readable memory and storing the result data in association with the particular client profile;
d. determining an association between the particular client and a representative user profile associated with the representative tier; and
a. at least partially on the basis of the presence of the result data and of the association between the representative user profile and the particular client, generating a report transmission comprising at least a portion of the result data and transmitting the report transmission to a representative remote device associated with the representative user profile.

18. The method of claim 17, wherein the set of tiers further comprises a manager tier, and wherein each tier is further associated with a different level of access to operational functions of the operational logic, the method further comprising:
a. receiving an interview request associated with a manager user profile from a manager remote device comprising an indication that the interview is to be conducted, and
b. transmitting the directive to the interviewer remote device at least in part in response to the interview request.

19. The method of claim 18, further comprising transmitting to the manager remote device a client list comprising a plurality of clients associated with the manager profile, and wherein the interview request is representative of a selection by a manager user associated with the manager user profile of the particular client from the client list.

20. The method of claim 18, further comprising in response to the interview request, accessing the computer-readable memory to generate in the computer-readable memory an indication that an interview is to be conducted for a particular client profile, and wherein
the step of generating the directive is done at least in part in response to the presence of the indication that an interview is to be conducted.

21. The method of claim 20, further comprising:
a. receiving a job request associated with the interviewer user profile from the interviewer remote device,
b. validating the job request to determine that the interviewer user profile is associated with the interview or the particular client, and
wherein the step of generating the directive is done at least in part in response the job request and the validation of the job request.

22. The method of claim 17, further comprising:
a. receiving a result request associated with the representative user profile,
b. in response to receiving the job request, accessing the computer-readable memory to determine that it comprises the result data and to validate the result request to determine that the representative user profile is associated with the result data, and
wherein the step of transmitting the report transmission to the remote device associated with the representative user profile is done at least in part on the basis of to the result request and the validation of the result request.

23. The method of claim 17, wherein the computer-readable memory further has at least one feedback campaign data set comprising question data, the question data indicative of at least one interview question to be asked orally to a client over the phone, the method further comprising:
a. accessing client data and feedback campaign data comprising at least a portion of the question data from the computer-readable memory, and
b. transmitting the client data and the feedback campaign data to the interviewer device along with the directive.

24. The method of claim 17, wherein the computer-readable memory further comprises remote device operational logic comprising computer-readable instructions instructing a remote device to generate a request to the server architecture to access computer-readable memory, the remote device operational logic comprising at least interviewer operational logic and representative operational logic, the method further comprising:
a. transmitting the interviewer operational logic to the interviewer remote device, and
b. transmitting the representative operational logic to the representative remote device.

25. The method of claim 17, further comprising:
a. automatically selecting the particular client for a subsequent interview a given period of time after receiving the result-providing transmission and generating a second directive indicative that a second interview is to be performed on the particular client and transmitting the second directive to the interviewer remote device associated with the interviewer user profile.

26. A centralized real-time performance monitoring system comprising a server architecture accessible for communication over a data network, the server architecture comprising:
a. a computer-readable memory comprising:
i. an operational data set comprising:
1. at least one feedback campaign data set comprising question data, the question data including at least one interview question to be asked orally to a client over the phone;
2. at least one client data set comprising a plurality of client profiles and comprising for each of the plurality of client profiles client profile data;
ii. a user data set comprising tiered user profiles each of which being of at least one tier from amongst at least a management tier, an interviewer tier, and a representative tier, wherein each tier is associated with a different level of access to the operational functions and data;
b. a network interface configured to receive requests from remote devices, the request being associated with a user profile and to transmit responses to requests to the remote device from which the corresponding request originated;
c. operational logic comprising computer-readable instructions for causing a processing entity to receive the access requests from the network interface, to implement an access gateway providing tiered access to the operational data and to operational logic functions, and to generate the responses to the access requests, the access gateway providing:
i. a manager tier access for requests associated with a manager tier user profile, the first tier access comprising access to:
1. functions to modify the campaign data from a particular feedback campaign profile in the operational data set;
ii. an interviewer tier access for requests associated with a interviewer tier user profile, the interviewer tier access comprising access to:
1. receive from the operational data set the client profile data from a particular client profile;
2. receive from the operational data said the feedback campaign profile data from a particular feedback campaign profile associated with the particular client profiles; and
3. provide to the operational data set response data associated with the particular client profile, the response data comprising answers to client question provided orally over the phone;
iii. a representative tier access for requests associated with a representative tier user profile, the representative tier access comprising access to:
1. receive from the operational data set the response data associated with the particular client profile.
